(19) United States
(12) Patent Application Publication
(10) Pub. No.: US 2015/0003228 A1
(43) Pub. Date: Jan. 1, 2015

(54) HANDLING SERVICES DURING DEVICE BACKOFF

(71) Applicant: BlackBerry Limited, Waterloo (CA)

(72) Inventors: Noun Choi, Flower Mound, TX (US); Stefano Faccin, Hayward, CA (US); Chen-Ho Chin, Deerlijk (BE)

(21) Appl. No.: 14/491,334

(22) Filed: Sep. 19, 2014

Related U.S. Application Data
(63) Continuation of application No. PCT/US13/31649, filed on Mar. 14, 2013.
(60) Provisional application No. 61/646,693, filed on May 14, 2012.
(60) Provisional application No. 61/614,144, filed on Mar. 22, 2012.

(51) Int. Cl. H04W 76/02; H04W 36/00

(52) U.S. Cl. CPC H04W 76/028; H04W 36/0022
USPC 370/216

(57) ABSTRACT

An example method to handle services during device backoff involves maintaining a device backed off from a packet-switched domain. When the device is backed off from the packet-switched domain, a request is sent to attach the device to an access network in a circuit-switched domain. A packet-switched backoff status of the device is sent with the request. The packet-switched backoff status indicates that the device is backed off from the packet-switched domain.

### RELATED APPLICATIONS

This is a continuation of International Patent Application Serial No. PCT/US2013/031649, filed Mar. 14, 2013, which claims priority to U.S. Provisional Patent Application No. 61/614,144, filed on Mar. 22, 2012, and to U.S. Provisional Patent Application No. 61/646,693, filed on May 14, 2012, all of which are hereby incorporated by reference herein in their entireties.

### FIELD OF THE DISCLOSURE

The present disclosure relates generally to wireless devices and, more particularly, to handling services during device backoff.

### BACKGROUND

Wireless terminals communicate with networks that provide access to different services and to large amounts of information. When a significant number of wireless terminals connected to a network are generating large quantities of exchanges with the network to access services and/or data, the network can become congested. Congested networks can lead to poor user experiences as the speeds with which wireless terminals can retrieve services or information are significantly reduced. In some instances, network congestion may lead to network failure, in which the network can no longer service any wireless terminal due to its level of congestion.

### BRIEF DESCRIPTION OF THE DRAWINGS

FIG. 1 depicts an example wireless network system having an example user equipment (UE) terminal in communication with an example circuit-switched (CS) domain and an example packet-switched (PS) domain.

FIG. 2 depicts an example messaging diagram in which the example UE of FIG. 1 re-selects the example CS domain while backed off of the example PS domain.

FIG. 3 depicts an example messaging diagram in which the example CS domain of FIG. 1 does not re-direct the example UE to the example PS domain.

FIG. 4 depicts an example messaging diagram in which the example UE of FIG. 1 provides a remaining backoff timer value that the CS domain uses to determine when to re-direct the example UE to the example PS domain.

FIG. 5 depicts an example messaging diagram in which the example UE of FIG. 1 provides a backoff timer value and pending CS services information used by the CS domain to determine when to re-direct the example UE to the example PS domain.

FIG. 6 depicts an example messaging diagram in which an example mobility management entity (MME) of FIG. 1 PS backs off the UE of FIG. 1 from the PS domain.

FIG. 7 depicts an example messaging diagram in which the example UE of FIG. 1 sends the example MME a tracking area update (TAU) request and an update-explanatory indication explaining why the UE is sending the TAU request.

FIG. 8 depicts an example messaging diagram in which, based on restricted services information from the PS domain, the example UE of FIG. 1 does not re-select the CS domain.

FIG. 9 depicts an example messaging diagram in which the example UE of FIG. 1 sends a routing area update (RAU) request even if it is backed off the PS domain.

FIG. 10 depicts an example messaging diagram in which the example UE of FIG. 1 sends a location area update (LAU) request to maintain an SGs interface association between a new mobile switching center (MSC) and a serving MME.

FIG. 11 is a flow diagram representative of machine readable instructions that may be executed by the example UE to implement the example messaging diagram of FIG. 2.

FIG. 12 is a flow diagram representative of machine readable instructions that may be executed by the example UE to implement the example messaging diagram of FIG. 3.

FIG. 13 is a flow diagram representative of machine readable instructions that may be executed by the example UE and the example CS domain of FIG. 1 to implement the example messaging diagram of FIG. 4.

FIG. 14 is a flow diagram representative of machine readable instructions that may be executed by the example UE and the example MME of FIG. 1 to implement the example messaging diagram of FIG. 5.

FIG. 15 is a flow diagram representative of machine readable instructions that may be executed by the example UE to implement the example messaging diagram of FIG. 6.

FIG. 16 is a flow diagram representative of machine readable instructions that may be executed by the example UE to implement the example messaging diagram of FIG. 7.

FIG. 17 is a flow diagram representative of machine readable instructions that may be executed by the example UE to implement the example messaging diagram of FIG. 8.

FIG. 18 is a flow diagram representative of machine readable instructions that may be executed by the example UE to implement the example messaging diagram of FIG. 9.

FIG. 19 depicts a detailed diagram of the example UE of FIG. 1 that may be used to implement example methods disclosed herein.

### DETAILED DESCRIPTION

Although the following discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following discloses example methods, apparatus, and articles of manufacture, persons having ordinary skill in the art will readily appreciate that the examples provided are not the only way to implement such methods, apparatus, and articles of manufacture.

It will be appreciated that, for simplicity and clarity of illustration, where considered appropriate, reference numerals may be repeated among the figures to indicate corresponding or analogous elements. In addition, numerous specific details are set forth in order to provide a thorough understanding of examples disclosed herein. However, it will be understood by those of ordinary skill in the art that examples disclosed herein may be practiced without these specific details. In other instances, well-known methods, procedures and components have not been described in detail so as not to obscure examples disclosed herein. Also, the description is not to be considered as limiting the scope of examples disclosed herein.

Example methods, apparatus, and articles of manufacture are disclosed herein in connection with user equipment (UE), which may be any mobile device or stationary device. Mobile devices include, for example, mobile communication devices, mobile computing devices, etc. Mobile devices, also referred to as terminals, wireless terminals, mobile stations, communication stations, or UE, may include mobile smart phones (e.g., BlackBerry® smart phones), wireless personal digital assistants (PDA), tablets (e.g., the BlackBerry® Playbook tablet device), laptop/notebook/netbook computers, etc. Stationary devices include, for example, desktop computers, computer terminals, kiosks, etc.

In wireless communication networks such as third generation partnership project (3GPP) networks and long term evolution (LTE) networks, a UE can use packet switched (PS) services through a PS domain, and can use circuit switched (CS) services through a CS domain. Packet switched services are often used to communicate asynchronous or isochronous data separable into different packets that can be sent to destinations via different network routes having different delays. In PS services, data can have non-synchronous and/or out of order times of arrival at destinations without adversely impacting the use of that data at the destinations. Circuit switched services are often used to communicate synchronous information that arrives at destinations in sequential order and at specific time of arrival requirements (e.g., not delayed) to provide a particular quality of service. Example PS services include file transfers and hyper text transfer protocol (HTTP) exchanges for web page retrieval. Example CS services include voice calls and short messaging service (SMS).

To provide a UE with access to a PS domain and a CS domain, a network includes an access network (AN) that provides PS services and an access network that provides CS services. Universal mobile telecommunications systems terrestrial radio access network (UTRAN) and a GSM/EDGE radio access network (GERAN) provide access to both CS domain and PS domain services, whereas Evolved UTRAN (E-UTRAN) provides access to only PS domain services. In E-UTRAN networks (also known as LTE networks), a UE that is attached to an E-UTRAN cannot access CS services through the PS domain, and must select attachment to the CS domain (e.g., a UTRAN or a GERAN). To switch from the PS domain to the CS domain, a UE combined registers with the PS domain to employ a circuit switched fall back (CSFB) feature that allows the UEs to re-select to attach to the CS domain whenever the UEs are to use CS services. Some UEs (e.g., tablet devices) are referred to as PS-only devices because they do not have CSFB capabilities. Such PS-only devices autonomously re-select to attach to CS domains without the use of CSFB whenever a CS service is to be used. Examples disclosed herein may be used in connection with UEs that use CSFB features when combined registered with a PS domain, and may also be used in connection with UEs that do not have CSFB capabilities and must autonomously re-select to attach to CS domains.

When signaling congestion occurs, a network may reject signaling requests from UEs and instruct the UEs to back off from using services for specified durations. For example, when signaling congestion in the PS domain occurs, a network entity (e.g., a MME or a SGSN) sends PS backoff timer values (e.g., Mobility Management backoff timers) to instruct the UEs to not access PS services for the durations indicated by the PS backoff timer values. When signaling congestion occurs in the CS domain, a CS domain network entity (e.g., MSC) sends CS backoff timer values to instruct the UEs to not access CS services for the durations indicated by the CS backoff timer values. Some 3GPP standards define the PS backoff timer as a T3346 timer, and define the CS backoff timer as a T3246 timer.

Examples disclosed herein are useful in different scenarios in which UEs are running PS backoff timers and need to re-select a radio access technology (RAT) to employ PS and CS services. An example scenario involves a UE being combined registered to the PS domain and to use PS services and to use CS services (e.g., including voice call services) through the CSFB feature. In such example scenario, the UE is PS backed off from the PS domain. When the UE is to use a mobile originated (MO) CS service (e.g., a voice call, an SMS service, etc.), the UE's upper layers (e.g., an application layer, a transport layer, or an Internet layer) trigger the CSFB feature of the UE, or an SMS entity (e.g., an SMS service handler of the UE that manages SMS exchanges for the UE) in the UE requests a non access stratum (NAS) (e.g., at the network layer of the UE) to send a SMS message. In such scenarios, as part of the CSFB process, or as part of the SMS transmission, the UE needs to perform evolved packet system (EPS) mobility management (EMM) signalling (e.g., PS signalling) to send an extended service request. However, because the UE is PS backed off in such scenarios, the UE cannot perform any PS signalling with the PS domain to request access to the CS domain.

Another example scenario involves a UE that is PS backed off while attached (e.g., camped) to a PS domain (e.g., in connected mode or in idle mode) that does not provide SMS service. In such scenarios, when the UE is to use a SMS service, a SMS entity of the UE needs to request the NAS (e.g., through PS signalling) to send an SMS message from the UE to the PS domain. However, because the UE is PS backed off in such scenarios, the UE cannot perform any PS signalling with the PS domain to request access to the CS domain.

In the above-described scenarios, prior techniques prevent a UE that is PS backed off from using PS signalling to initiate access to CS services even though the UE is not CS backed off. In such scenarios, prior techniques involve UEs autonomously selecting to attach to the CS domain using CS signalling without assistance from the PS domain through PS signalling. Thus, UEs use such prior techniques without management assistance from the PS domain to facilitate switching between the PS domain and the CS domain. The lack of PS domain assistance in managing UE switches between the PS domain and the CS domain leads to poor performance of UEs and networks.

An example drawback of prior techniques involves a UE that was previously camped on a first PS domain AN (e.g., a first E-UTRAN) in a first tracking area (TA) and that is re-directed by a CS domain to a second PS domain AN (e.g., a second E-UTRAN) in a second TA after completing use of CS services. Tracking areas are used by a mobility management entity (MME) to identify where to reach UEs registered in the PS domain. If the UE is still PS backed off when the UE registers with the second PS domain, the UE cannot use PS signalling to perform a required tracking area update (TAU) in the PS domain to update its TA for a MME of a network to know where to deliver communications for the UE. Thus, any communications (e.g., paging) from the MME to the UE will be delayed until a PS backoff timer of the UE expires, and the UE is able to use PS signalling to perform a TAU to update its TA.

Another example drawback of prior techniques involves a UE that performs numerous re-selections and re-directions back and forth between a PS domain and a CS domain when the UE needs to exchange numerous communications using CS services (e.g., a user of the UE is involved in a chat or conversation involving numerous SMS message exchanges). Such numerous re-selections and re-directions are a result of multiple discrete CS service uses (e.g., different SMS message exchanges) that cause a UE to re-select to attach to the CS domain (e.g., re-selections) whenever it needs to use a CS service (e.g., send a single SMS message) and that cause a CS domain to re-direct the UE to the PS domain (e.g., re-directions) when the UE finishes a single CS service transaction (e.g., sends or receives a single SMS message of a plurality of exchanged SMS messages). Such numerous re-selections and re-directions decrease battery life of the UE due to, for example, the scanning, returning, and re-camping procedures performed during each re-selection.

Another example drawback of prior techniques involves a UE that is re-directed to and/or re-selects a PS domain after the UE has performed a location area update (LAU) while in the CS domain. The UE performs a LAU to update its current location area (LA) to select a mobile switching center (MSC) that serves the current LA. For instances in which the UE is moving or is on a boundary between two LAs, the UE may select a new MSC when it performs a LAU that is different from a previous selected MSC to which the UE was combined registered when in the PS domain. In such instances, when the UE returns to the PS domain and the UE is PS backed off, the UE cannot use PS signalling to perform a combined tracking area update (TAU) in the PS domain to update a MME in the PS domain with its new LA identifier (LAI) corresponding to the new MSC with which the UE registered when in the CS domain. As such, the UE will be camped on the PS domain, but it will be unreachable for mobile terminated (MT) CS (MTCS) services (e.g., communications to be delivered to, or terminated at, the UE) such as incoming voice calls or incoming SMS messages. In such instances, MTCS services to the UE will fail because the MME in the PS domain does not have an interface (e.g., an SGs interface defined by 3GPP standards) with the new MSC and, thus, CS paging for the UE cannot be delivered to the MME to enable MTCS services for the UE while in the PS domain.

Another example drawback of prior techniques involves allowing too many devices to simultaneously use CS services (e.g., SMS messaging, voice call services, unstructured supplementary services data (USSD), location services (LCS), CS data services, etc.) through CS re-reselection. If a PS domain encounters congestion and backs off a number of UEs, the backed off UEs cannot use CS services when connected to the PS domain. In such instances, a large quantity of the PS backed off UEs may concurrently or substantially concurrently re-select the CS domain when they need to use CS services, because they cannot access such CS services from the PS domain when they are PS backed off. Such numerous UE re-selections of the CS domain may cause a signalling flood (e.g., to a short messaging service center (SMSC)) even when the PS domain has intended to stop UEs from flooding the network through the use of PS backoff. As such, this drawback of prior techniques is that the use of PS backoff to prevent further network congestion actually results in more network congestion by causing numerous UEs to re-select the CS domain when needing to access CS services and cannot signal requests for such CS services through the PS domain.

Example methods, apparatus, and articles of manufacture disclosed herein may be used to facilitate handling CS services while UEs are backed off of PS domains. Some disclosed examples enable a UE to perform tracking area updates (TAUs), even when it is PS backed, off so that an MME of a network is updated with the TA at which to deliver communications to the UE. In this manner, communications (e.g., paging) from the MME to the UE may not be delayed until a PS backoff timer of the UE expires. Some disclosed examples substantially decrease the number of re-selections and re-directions of a UE to switch between a PS domain and a CS domain when the UE needs to exchange numerous communications using CS services. In this manner, operating performance and battery life of a UE can be improved by spending less resources and power to perform, for example, scanning, returning, and re-camping procedures during each re-selection. Some disclosed examples enable a UE to perform tracking area updates (TAUs), even when it is PS backed off, so that interfaces between an MME and a new MSC (corresponding to a new LA of the UE) can be established to provide MTCS services to the UE. In this manner, CS paging for the UE can be delivered to the MME to enable MTCS for the UE while in the PS domain without needing to wait until PS backoff time of the UE is expired. Some disclosed examples enable a network to restrict UEs from using particular services to prevent large quantities of UEs from concurrently requesting access to such restricted, which could lead to network flooding and congestion.

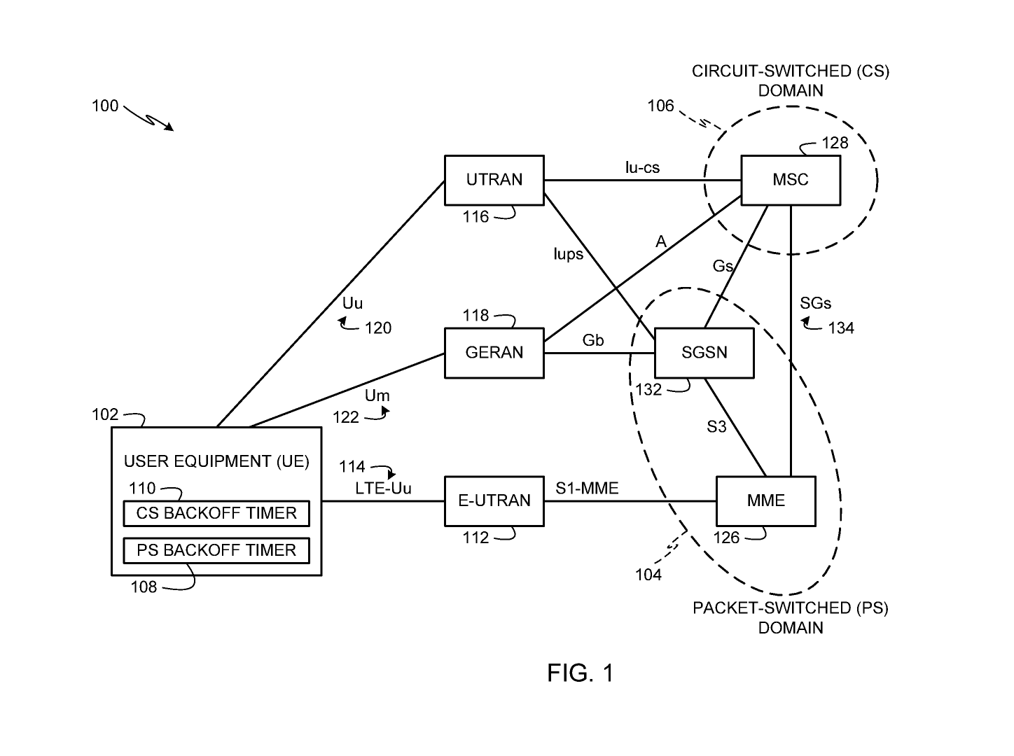

FIG. 1 depicts an example wireless network system 100 having an example user equipment (UE) terminal 102 in communication with an example packet-switched (PS) domain 104 and an example circuit-switched (CS) domain 106. In the illustrated example, the wireless network system 100 is a combined LTE (e.g., 4G) and 3G network (e.g., GSM-UMTS, CDMA2000, etc.). In the illustrated example, a E-UTRAN 112 form an LTE access network that provides access to the PS domain 104 to provide the UE 102 with PS services, and a UTRAN 116 and GERAN 118 form 3G access networks that also provide access to the PS domain 104 to provide the UE 102 with PS services. Also in the illustrated example, the UTRAN 116 and GERAN 118 access networks provide access to the CS domain 106 to provide the UE 102 with CS services. In the illustrated example, while the PS domain 104 provides the UE 102 with PS services, the PS domain 104 does not provide the UE 102 with CS services. Instead, the E-UTRAN 112 provides a CSFB service that enables the UE 102 to use the CS domain 104 to access CS services by defining how the UE 102 can switch its radio to re-select from the PS domain 104 to other radio access technologies (RATs) (e.g., the UTRAN 116 and/or the GERAN 118) to access the CS domain 104. For example, when the UE 102 is camped on the PS domain 104 and needs to use a mobile originated (MO) CS service (e.g., make a voice call, send an SMS message, use a USSD service, use location services (LCS), use CS data services, etc.), the CSFB service assists the UE 102 to re-select the CS domain 106 to use such MOCS service. In addition, when the UE 102 is camped on the PS domain 104 and the UE 102 receives a mobile terminating (MT) CS service (e.g., receiving a voice call, receiving an SMS message, receive a USSD transmission, receive a LCS transmission, receive CS data, etc.), the CSFB service assists the UE 102 to re-select the CS domain 106 accept the MTCS service. Some UEs do not use CSFB services, and instead switch autonomously from PS domains to CS domains without assistance from CSFB services. Examples disclosed herein may be used in connection with CSFB services and without CSFB services.

The UE 102 of the illustrated example includes a PS backoff timer 108 and a CS backoff timer 110. In the illustrated example, the PS backoff timer 108 is a mobility management backoff timer (e.g., a 3GPP-defined T3346 timer). The UE 102 uses the PS backoff timer 108 to track a duration for which the UE 102 is PS backed off from the PS domain 104. For example, when the PS domain 104 detects congestion, the PS domain 104 sends the UE 102 a PS backoff timer value indicative of a duration for which the UE 102 is PS backed off and, thus, should not use PS signaling to the PS domain 104 to use PS services. The UE 102 uses the CS backoff timer 110 to track a duration for which the UE 102 is CS backed off from the CS domain 106. For example, when the CS domain 106 detects congestion, the CS domain 106 sends the UE 102 a CS backoff timer value indicative of a duration for which the UE 102 is CS backed off and, thus, should not use CS signaling to the CS domain 106 to use CS services. In the illustrated example, the PS backoff timer 108 is implemented using a 3GPP-defined T3346 timer (e.g., a mobility management backoff timer), and the CS backoff timer 110 is implemented using a 3GPP-defined T3246 timer.

In the illustrated example of FIG. 1, the E-UTRAN 112 RAT provides LTE services, and communicates with the UE 102 via a 3GPP-defined LTE-Uu air interface 114. Also in the illustrated example, the UTRAN 116 RAT provides WCDMA access technology, and the GERAN 118 RAT of the illustrated example provides GSM/EDGE access technology. In the illustrated example, the UE 102 may communicate with the UTRAN 116 via a 3GPP-defined Uu air interface 120. Alternatively, the UE 102 may communicate with the GERAN via a 3GPP-defined Um air interface 122. For example, if the UE 102 has a WCDMA radio, the UE 102 can access CS services in the CS domain 106 by attaching to the UTRAN 116. Alternatively, if the UE 102 has a GSM radio, the UE 102 can access CS services in the CS domain 106 by attaching to the GERAN 118.

Examples disclosed herein may be used in instances in which the UE 102 uses the UTRAN 116 or the GERAN 118 to access CS services, because the E-UTRAN 112 does not provide access to the CS domain 106 to access CS services. Accordingly, in examples disclosed herein, the E-UTRAN 112 is referred to as providing access to the PS domain 104, and the UTRAN 116 and the GERAN 118 are referred to as providing access to the CS domain 106 because the UE 102 uses the E-UTRAN 112 for PS services and uses the UTRAN 116 and/or the GERAN 118 for CS services. In the illustrated example of FIG. 1, and as discussed above, the UE 102 may also access PS services via the UTRAN 116 and/or the GERAN 118.

The wireless network system 100 of the illustrated example is also provided with an example mobility management entity (MME) 126, an example mobile switching center (MSC) server 128, and an example serving GPRS (general packet radio service) support node (SGSN) 132. The example MME 126 is a control node for the E-UTRAN 112. In the illustrated example, the MME 126 performs tracking of UE 102 when it is in idle mode to determine the tracking areas (TAs) in which the UE 102 is located. In addition, the MME 126 performs paging procedures to notify the UE 102 of mobile terminated services (e.g., calls, messages, data, etc.) sent to the UE 102 from other UEs and/or from network entities. The example MSC server 128 is the primary service delivery node for CS services in 3G networks (e.g., GSM/EDGE networks and WCDMA networks). In the illustrated example, the MSC server 128 routes CS services such as voice calls, SMS messages, USSD transmissions, location services (LCS) transmissions, CS data, and other CS services to UEs. The MSC server 128 stores location areas (LAs) of UEs to determine LAs at which to reach the UEs. The example SGSN 132 is the primary service delivery node for PS services in 3G GPRS networks. In the illustrated example, the SGSN 132 routes PS data to UEs attached to the UTRAN 116 and the GERAN 118.

In the illustrated example, to implement the CSFB feature in the PS domain 104, the MSC server 128 is in communication with the MME 126 via the 3GPP-defined SGs interface 134. An SGs interface 134 enables the MSC server 128 to signal the MME 126 whenever the MSC server 128 receives a MTCS call or transmission (e.g., an SMS message) intended for the UE 102 that is attached to the E-UTRAN 112. In this manner, the MME 126 and the E-UTRAN 112 can page the UE 102 to notify it of the MTCS call or transmission, and can use the CSFB feature to determine how the UE 102 should re-select the CS domain 106 to receive the MTSC call or transmission. In the illustrated example, when the UE 102 moves to a LA managed by the MSC server 128, the UE 102 performs a location area update (LAU) to register with the MSC server 128. When the UE 102 performs a tracking area update (TAU) with the MME 126, the MSC server 128 establishes a SGs interface 134 with the MME 126 for the UE 102 so that the MSC server 128 can reach the UE 102 to notify it of any MTCS calls or transmissions when the UE 102 is camped on the PS domain 104. When the UE 102 moves to a different LA and de-registers with the MSC server 128, the MSC server 128 tears down the SGs interface 134 that it previously established for the UE 102.

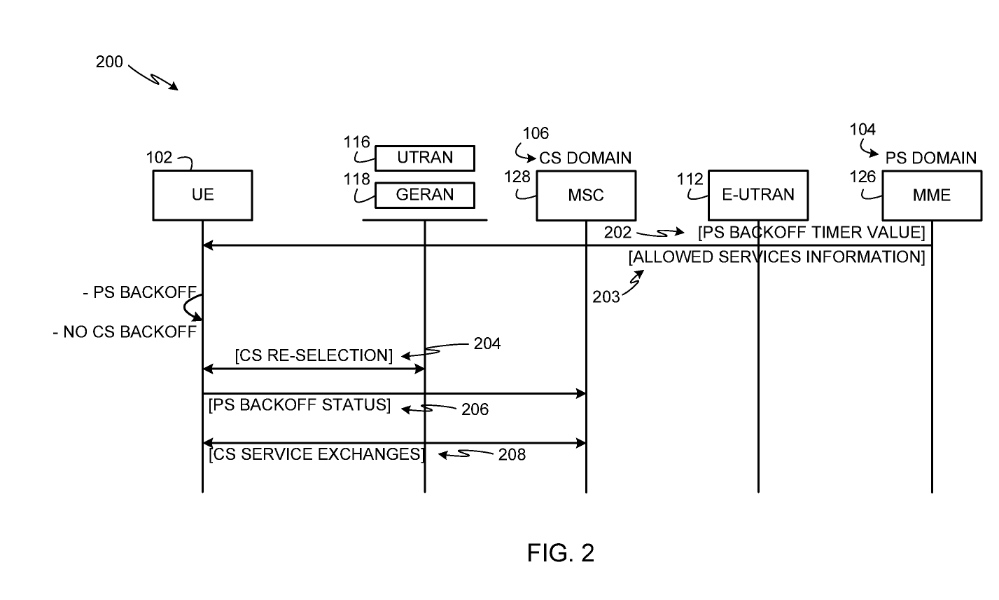

FIG. 2 depicts an example messaging diagram 200 in which the example UE 102 of FIG. 1 re-selects the example CS domain 106 (FIG. 1) while backed off of the example PS domain 104 (FIG. 1). In the illustrated example of FIG. 2, the UE 102 receives a PS backoff timer value 202 from the MME 126 (FIG. 1), which generates and sends the PS backoff timer value 202 in a mobility management (MM) service reject message in response to congestion in the PS domain 104 when the UE 102 requests to access a service in the PS domain 104. For example, the PS backoff timer value 202 may be in response to the UE 102 performing a service request procedure (e.g., requesting a service from the PS domain 104), performing a combined attach procedure (e.g., to receive PS services and to receive circuit-switched (CS) fallback (CSFB) services from the PS domain 104), or performing a combined TAU in which the UE 102 sends a TAU request to the MME 126 (FIG. 1), or another routing area update (RAU) request to the SGSN 132 (FIG. 1). In other examples, the UE 102 may receive the PS backoff timer value 202 from the SGSN 132 of FIG. 1. The PS backoff timer value 202 indicates a duration for which the UE 102 is PS backed off from the PS domain 104 and, thus, is prohibited from sending PS signaling to the PS domain 104. The UE 102 loads the PS backoff timer value 202 into its PS backoff timer 108 (FIG. 1) and starts the PS backoff timer 108 to countdown the duration of the PS backoff timer value 202. When the PS backoff timer 108 expires, the UE 102 is no longer PS backed off.

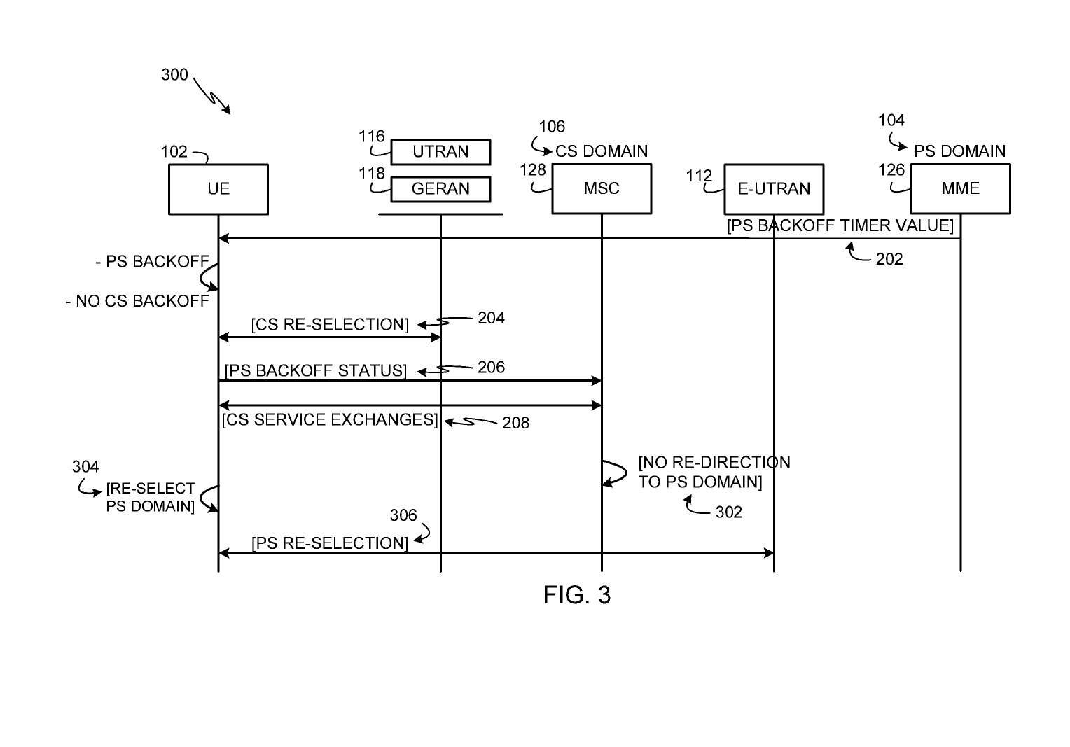

In some examples, the MME 126 also sends the UE 102 allowed services information 203 along with the MM reject message containing the PS backoff timer value 202. In the illustrated example, the allowed services information 203 indicates CS services (e.g., SMS messaging, voice call services, USSD services, LCS, CS data services, etc.) that the UE 102 is allowed to initiate by re-selecting to attach to the CS domain 106 while the PS backoff timer 108 is running (e.g., the UE 102 is PS backed off) and the CS backoff timer 110 is not running (e.g., the UE 102 is not CS backed off). For example, the CS domain 106 may have sufficient resources to provide UEs with types of CS services indicated as allowed CS services in the allowed services information 203. In the some examples, the MME 126 (or the SGSN 132) generates and sends the allowed services information 203 with the PS backoff timer value 202 in the same MM service reject message (not shown) via the PS domain 104 in response to congestion in the PS domain 104 when the UE 102 requests to access a service in the PS domain 104. In this manner, the MME 126 (or the SGSN 132) may prevent flooding of the CS domain 106 by controlling when UEs (e.g., the UE 102) may re-select to the CS domain 106 to initiate CS services indicated in the allowed services information 203 as allowed CS services, and/or to prevent the UEs from re-selecting to the CS domain 106 when desiring to access CS services not indicated in the allowed services information 203 as allowed CS services. Although not shown in other messaging diagrams described below, any of the messaging diagrams of FIGS. 3-10 may also involve the PS domain 104 sending the allowed services information 203 with the PS backoff timer value 202 when the PS domain 104 sends a MM service reject message to reject a request to access a service through the PS domain 104.

In some examples, the allowed services information 203 is referred to as an additional CS service update result that updates the UE 102 on services for which it is allowed to re-select to the CS domain 106. In some examples, the allowed services information 203 is implemented using an information element (IE) field in a MM service reject message, and the allowed services are indicated using different bit encodings in the IE field. In some examples, each unique bit encoding (e.g., bit encoding 00, 01, 10, 11 in a two-bit IE field) may be used to represent a different allowed service. In some examples, multiple allowed services may be indicated together using a single bit encoding. For example, a bit encoding of 01 in the IE field may indicate that the UE 102 is allowed to re-select to the CS domain 106 to access one or both of CS voice services and/or SMS messaging services when the PS backoff timer 108 is running.

When the UE 102 is PS backed off (e.g., the PS backoff timer 108 is running) from the PS domain 104 but not CS backed off (e.g., the CS backoff timer 110 is not running) from the CS domain 106, the UE 102 re-selects to attach to the CS domain 106 (e.g., the UTRAN 116 or the GERAN 118) by performing a CS re-selection procedure 204 (e.g., a radio resource control (RRC) connection establishment with a target RAT) with the UTRAN 116 or the GERAN 118 to attach to the CS domain 106. For example, the UE 102 may autonomously re-select to attach to the CS domain 106, or the PS domain 104 re-directs the UE 102 to the CS domain 106 in accordance with CSFB procedures. In some examples, the UE 102 re-selects to attach to the CS domain 106 when upper layers (e.g., an application layer, a transport layer, or an Internet layer) of the UE 102 request for mobile originated (MO) CSFB. In examples in which the UE 102 receives the allowed services information 203, the UE 102 re-selects to the CS domain 106 by performing the CS re-selection procedure 204 when the CS service(s) that the UE 102 intends to use is/are indicated as allowed in the allowed services information 203.

In the illustrated example, the UE 102 also sends an indication of a PS backoff status 206 to the MSC server 128 in the CS domain 106 using CS signaling (e.g., MM or call control (CC) signaling). The PS backoff status 206 informs the CS domain 106 that the UE 102 has been backed off from the PS domain 104. In the illustrated example, the UE 102 proceeds with CS service exchanges 208 (e.g., MM and call control (CC) procedures) between the UE 102 and the CS domain 106 to establish/use the requested CS service. In some examples, the UE 102 re-selecting to attach to the CS domain 106 involves the upper layers of the UE 102 requesting for mobile originated lx CSFB, and involves the UE 102 selecting cdma2000® 1x RAT and proceeding with cdma2000® 1x CS call procedures.

In the illustrated example, the CS domain 106 may use the PS backoff status 206 to determine whether and/or when to re-direct the UE 102 back to the PS domain 104. In this manner, re-directions and re-selections performed by the UE 102 between the PS domain 104 and the CS domain 106 can be substantially reduced relative to prior techniques. That is, the CS domain 106 can determine based on the PS backoff status 206 that there is less of an urgency for the UE 102 to return to the PS domain 104. As such, the CS domain 106 may allow the UE 102 to remain camped on the UTRAN 116 or the GERAN 118 so that if the UE 102 should subsequently access another CS service before its PS backoff timer 108 (FIG. 1) expires, the UE 102 is already on the CS domain 106 and does not need to re-select the CS domain 106 from the PS domain 104.

FIG. 3 depicts an example messaging diagram 300 in which the example CS domain 106 does not re-direct the example UE 102 to the example PS domain 104. The example messaging diagram 300 shows the PS backoff timer value 202, the CS re-selection procedure 204, the PS backoff status 206, and the CS service exchanges 208 of FIG. 2. In the illustrated example, after the CS domain 106 receives the PS backoff status 206 from the UE 102, and after the UE 102 finishes using the requested CS service (e.g., the CS services exchanges 208), the CS domain 106 does not re-direct the UE 102 to the PS domain 104, as represented by reference numeral 302. In some examples, the CS domain 106 not redirecting the UE 102 to the PS domain 104 after finishing use of the CS service involves the CS domain 106 selecting an RAT/frequency selection priority (RFSP) index that allows, encourages, or forces the UE 102 to remain in the CS domain 106 after finishing use of the CS service. For example, the CS domain 106 may set the RFSP index for the UE 102 to give the UTRAN 116 or the GERAN 114, which provide access to the CS domain 106, the higher priority relative to the E-UTRAN 112, which provides access to the PS domain 104. In this manner, the UE 102 prioritizes camping on the UTRAN 116 or the GERAN 114 rather than re-selecting to attach to the PS domain 104 via the E-UTRAN 112.

In the illustrated example, the UE 102 determines when to re-select to the PS domain 104 as shown at reference numeral 304, and the UE 102 performs a PS re-selection procedure 306 (e.g., RRC connection establishment with a target RAT) with the E-UTRAN 112 to attach to the PS domain 104. In some examples, the UE 102 re-selects to attach to the PS domain 104 after the PS backoff timer 108 expires. In other examples, the UE 102 re-selects to attach to the PS domain 104 before the PS backoff timer 108 expires based on, for example, determining that it no longer requires use of CS services for some subsequent duration. In such other examples, the UE 102 is not able to obtain MT data services in the PS domain 104 before the PS backoff timer 108 expires. For instances in which the UE 102 re-selects to attach to the PS domain 104 before the PS backoff timer 108 expires, and the UE 102 has performed a LAU (e.g., to an MSC server, which is different from the MSC 128 with which the MME 126 has an established SGs interface 134 as shown in FIG. 1) while attached to the CS domain 106, the MSC server 128 cannot route MT CS calls to the UE 102 until the PS backoff timer 108 expires (so that the UE 102 can perform another LAU from the PS domain 104) or until the UE 102 receives a paging from the MME 126.

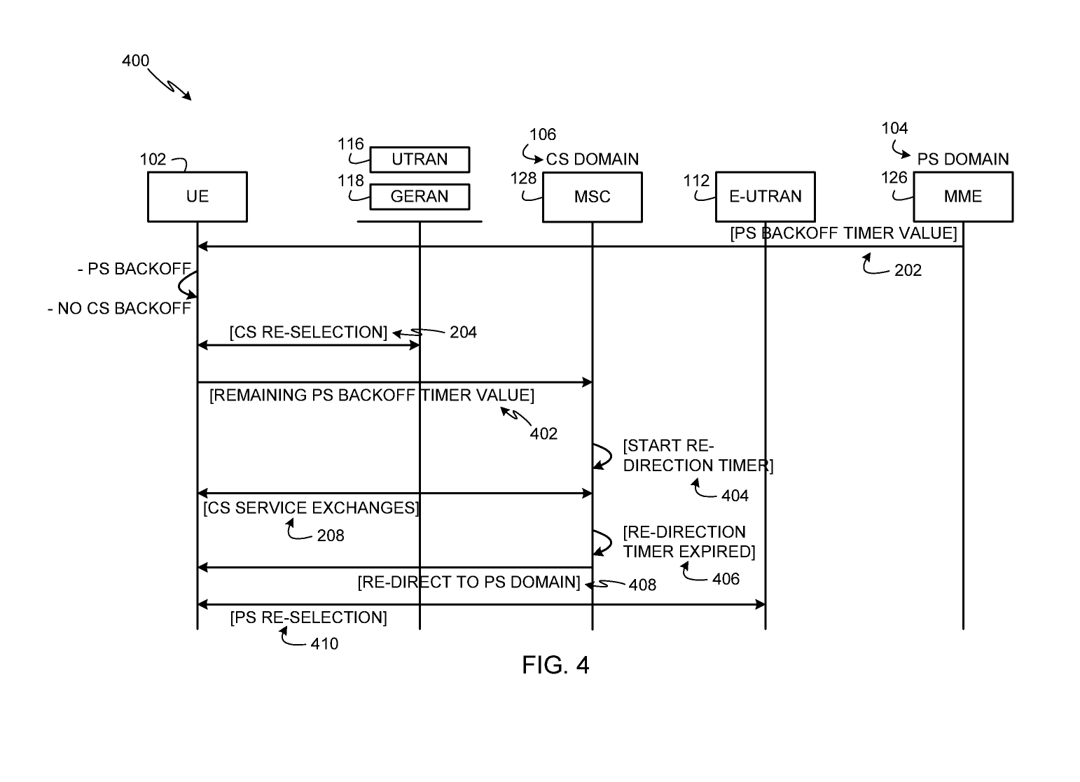

FIG. 4 depicts an example messaging diagram 400 in which the example UE 102 provides a remaining backoff timer value 402 to the CS domain 106 so that the CS domain 106 can determine when to re-direct the UE 102 to the example PS domain 104. The example messaging diagram 400 shows the PS backoff timer value 202, the CS re-selection procedure 204, and the CS service exchanges 208 of FIGS. 2 and 3. In the illustrated example of FIG. 4, when the UE 102 re-selects to attach to the CS domain 106, the UE 102 provides the remaining PS backoff timer value 402 of the PS backoff timer 108 to the CS domain 106. Although not shown in FIG. 4, the UE 102 may also send the PS backoff status 206 of FIGS. 2 and 3 to the CS domain 106 in addition to the remaining PS backoff timer value 402. The remaining PS backoff timer value 402 of the illustrated example indicates the remaining duration, as tracked by the PS backoff timer 108, for which the UE 102 must remain PS backed off.

In the illustrated example, after the CS domain 106 receives the remaining PS backoff timer value 402, the CS domain 106 starts a re-direction timer for the UE 102 as shown by reference numeral 404. In the illustrated example, the CS domain 106 does not re-direct the UE 102 to the PS domain 104 until after the re-direction timer expires. In the illustrated example, the CS domain 106 not re-directing the UE 102 to the PS domain 104 after the UE 102 finishes using the requested CS service(s) involves the CS domain 106 selecting an RFSP index that allows or encourages or forces the UE 102 to remain in the CS domain 106 after using the CS service(s). When the re-direction timer expires 406 at the CS domain 106, the CS domain 106 sends a re-direction 408 (re-direct to PS domain) to the UE 102 to re-direct the UE 102 to the PS domain 104. In the illustrated example, because the re-direction timer maintained by the CS domain 106 starts using the remaining PS backoff timer value 402 from the UE 102, the re-direction timer at the CS domain 106 expires at the same time as, or shortly after (due to transmission delay of the remaining PS backoff timer value 402), as the PS backoff timer 108 FIG. 1) at the UE 102. In this manner, the CS domain 106 can re-direct the UE 102 back to the PS domain 104 after the UE 102 is no longer PS backed off. The UE 102 of the illustrated example then re-selects to attach to the PS domain 104 by performing a PS re-selection procedure 410 with the E-UTRAN 112.

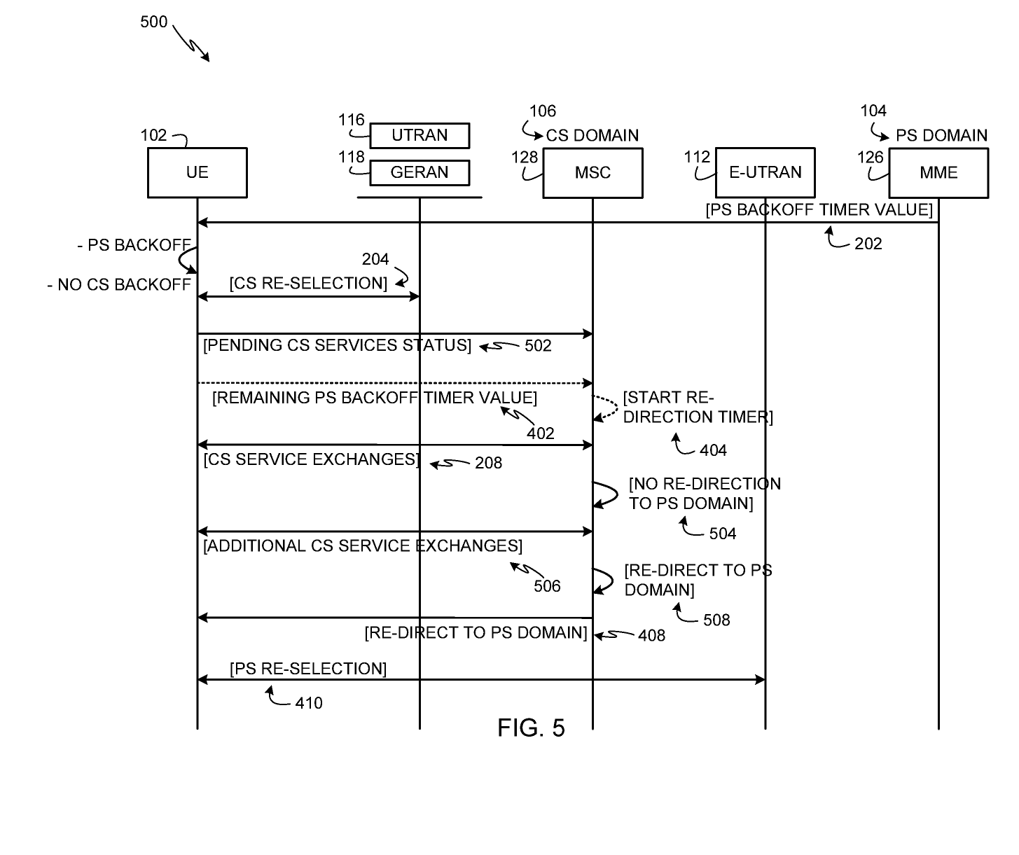

FIG. 5 depicts an example messaging diagram 500 in which the example UE 102 provides a pending CS services status 502 of CS services to be used by the CS domain 106 to determine when to re-direct the example UE 102 to the example PS domain 104. The example messaging diagram 500 shows the PS backoff timer value 202, the CS re-selection procedure 204, and the CS service exchanges 208 of FIGS. 2-4. In the example messaging diagram 500, the UE 102 is PS backed off and re-selects (e.g., autonomously re-selects or is re-directed by the PS domain 104 based on CSFB) to attach to the CS domain 106 (e.g. to send an SMS message). When the UE 102 re-selects to attach to the CS domain 106, the UE 102 sends the pending CS services status 502 to the CS domain 106. In the illustrated example, the pending CS services status 502 indicates that there are requested/pending CS services that the UE 102 intends to use while attached to the CS domain 106. In the illustrated example, the pending CS services status 502 indicates the number of CS services and which CS services that the UE 102 intends to request and use. In some examples, the UE 102 provides an “SMS follow on” indication in the pending CS services status 502 to indicate that the UE 102 will send and/or receive further SMS messages when attached to the CS domain 106.

After the CS domain 106 receives the pending CS services status 502, the CS domain 106 does not re-direct the UE 102 to the PS domain 104 as shown by reference numeral 504 after the UE 102 finishes using a first requested CS service (e.g., the CS service exchanges 208). In the illustrated example, the UE 102 remains on the CS domain 106 to use additional CS services (e.g., additional CS service exchanges 506) indicated in the pending CS services status 502. In the illustrated example, the CS domain 106 not re-directing the UE 102 to the PS domain 104 after the UE 102 finishes using the CS service(s) involves the CS domain 106 selecting an RFSP index that allows or forces the UE 102 to remain in the CS domain 106 after using the CS service(s).

In the illustrated example of FIG. 5, the CS domain 106 determines that it should re-direct the UE 102 to the PS domain 104 (as referred to by reference numeral 508) after the UE 102 has finished using the CS services indicated in the pending CS services status 502. In FIG. 5, the CS domain 106 sends a re-direction 408 (re-direct to PS domain) to the UE 102 to re-direct the UE 102 to the PS domain 104. The UE 102 of the illustrated example then re-selects to attach to the PS domain 104 by performing a PS re-selection procedure 410 with the E-UTRAN 112.

In some examples, when the UE 102 re-selects to attach to the CS domain 106 (e.g., by performing the CS re-selection procedure 204), the UE 102 also provides the remaining PS backoff timer value 402 of the PS backoff timer 108 to the CS domain 106. In such examples, after receiving the remaining PS backoff timer value 402, the CS domain 106 starts a re-direction timer 404 for the UE 102. In such examples, the CS domain 106 does not re-direct the UE 102 to the PS domain 104 (e.g., as represented by reference numeral 504) after the UE 102 finishes using a first CS service represented by the CS service exchanges 208 because the UE 102 has yet to finish using the CS services indicated in the pending CS services status 502 and/or because the re-direction timer started by the CS domain 106 for the UE 102 has not yet expired.

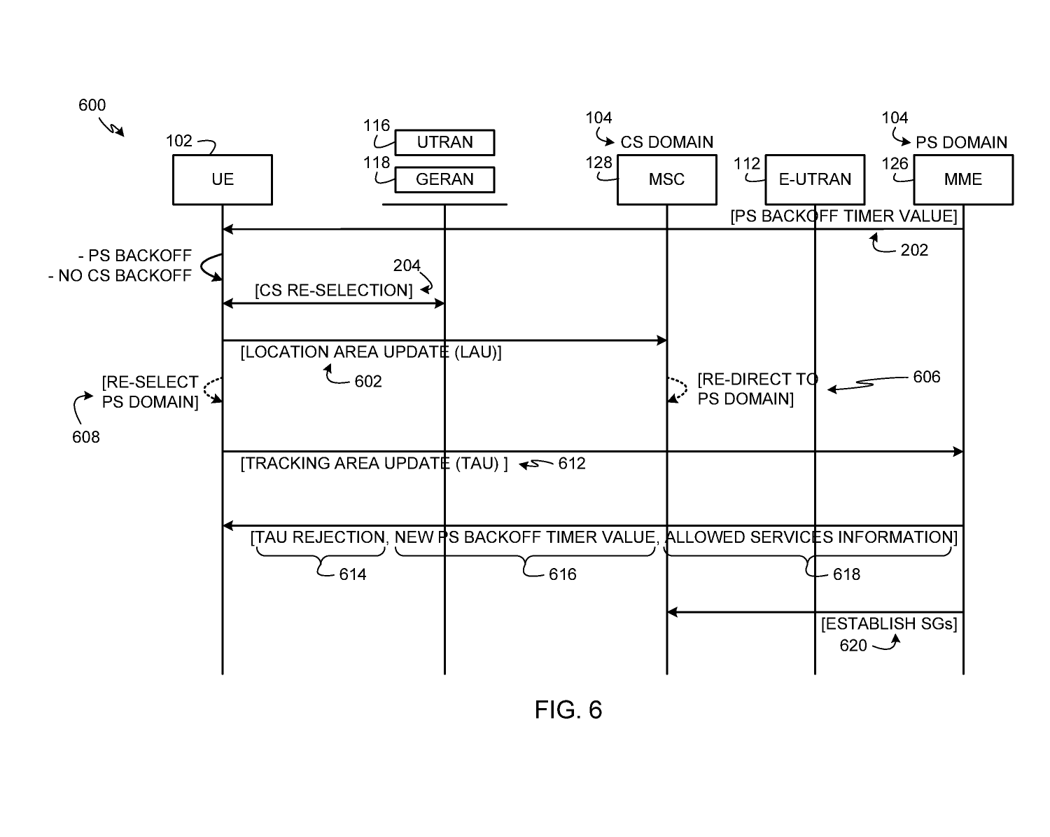

FIG. 6 depicts an example messaging diagram 600 in which the mobility management entity (MME) 126 of FIG. 1 PS backs off the UE 102 from the PS domain 104. In the illustrated example of FIG. 6, the PS domain 104 PS backs off the UE 102 using the PS backoff timer value 202, and the UE 102 re-selects to attach to the CS domain 106 by performing the CS re-selection procedure 204. In FIG. 6, the UE 102 sends the MSC server 128 a location area update (LAU) request 602 to perform a LAU in the CS domain 106. In some examples, the CS domain 106 re-directs the UE 102 to the PS domain 104 as referred to by reference numeral 606. For example, the CS domain 106 may re-direct the UE 102 to the PS domain 104, after the UE 102 enters into idle mode, by sending the UE 102 idle mode camping policies that force the UE 102 to return to the PS domain 104, or by sending the UE 102 an RFSP index that prioritizes the PS domain 104 higher than the CS domain 106. In other examples, the UE 102 autonomously determines to re-select to attach to the PS domain 104 as referred to by reference numeral 608.

In the illustrated example of FIG. 6, after the UE 102 performs the LAU (e.g., using the LAU request 602), the UE 102 returns to the PS domain 104 even if the UE 102 is still PS backed off. For example, the UE 102 performs a tracking area update (TAU) by sending the MME 126 a TAU request 612, even if the UE 102 is still PS backed off. Using the TAU 612 of the illustrated example, the UE 102 performs a combined registration to attach to the PS domain 104 to receive PS services and to receive circuit-switched (CS) fallback (CSFB) services from the PS domain 104. In the illustrated example, the UE 102 performs the TAU 612 even if the UE 102 is still in the same public land mobile network (PLMN) and in the same TA in which the UE 102 was located when previously registered in the PS domain 104. In other examples, the UE 102 performs a combined TAU in which it sends the TAU request 612 to the MME 126 and another TAU request to the SGSN 132 of FIG. 1. Performing a TAU enables the UE 102 to remain combined registered (e.g., to receive CSFB service in the PS domain 104) in the PS domain 104 after finishing use of the requested CS service, even if the UE 102 is PS backed off.

In the illustrated example of FIG. 6, after receiving the TAU request 612 from the UE 102, the MME 126 rejects the TAU request 612 (e.g., by sending the UE 102 a TAU rejection 614) and sends the UE 102 a new PS backoff timer value 616. In this manner, the UE 102 can load and run its PS backoff timer 108 with the new PS backoff timer value 616 so that the UE 102 remains PS backed off for the duration of the new PS backoff timer value 616.

In some examples, the MME 126 also sends the UE 102 allowed services information 618 that indicates CS services (e.g., SMS messaging, voice call services, USSD services, LCS, CS data services, etc.) that the UE 102 is allowed to initiate by re-selecting to attach to the CS domain 106 while the PS backoff timer 108 is running (e.g., the UE 102 is PS backed off) and the CS backoff timer 110 is not running (e.g., the UE 102 is not CS backed off). For example, the CS domain 106 may have sufficient resources to provide UEs with types of CS services indicated as allowed CS services in the allowed services information 618. In this manner, the MME 126 may prevent flooding of the CS domain 106 by controlling when UEs (e.g., the UE 102) may re-select to the CS domain 106 to initiate CS services indicated in the allowed services information 618 as allowed CS services, and/or to prevent the UEs from re-selecting to the CS domain 106 when desiring to access CS services not indicated in the allowed services information 618 as allowed CS services.

In some examples, the allowed services information 618 is referred to as an additional CS service update result that updates the UE 102 on services for which it is allowed to re-select to the CS domain 106. In some examples, the allowed services information 618 is implemented using an information element (IE) field in a MM service reject message, and the allowed services are indicated using different bit encodings in the IE field. In some examples, each unique bit encoding (e.g., bit encoding 00, 01, 10, 11 in a two-bit IE field) may be used to represent a different allowed service. In some examples, multiple allowed services may be indicated together using a single bit encoding. For example, a bit encoding of 01 in the IE field may indicate that the UE 102 is allowed to re-select to the CS domain 106 to access one or both of CS voice services and/or SMS messaging services when the PS backoff timer 108 is running.

In the illustrated example, the MME 126 establishes the SGs interface 134 (FIG. 1) with the MSC server 128 (FIG. 1) corresponding to the LA provided by the UE 102 as indicated by reference numeral 620. In this manner, the PS domain 104 can page the UE 102 for MTCS services if congestion is resolved before the PS backoff timer 108 expires.

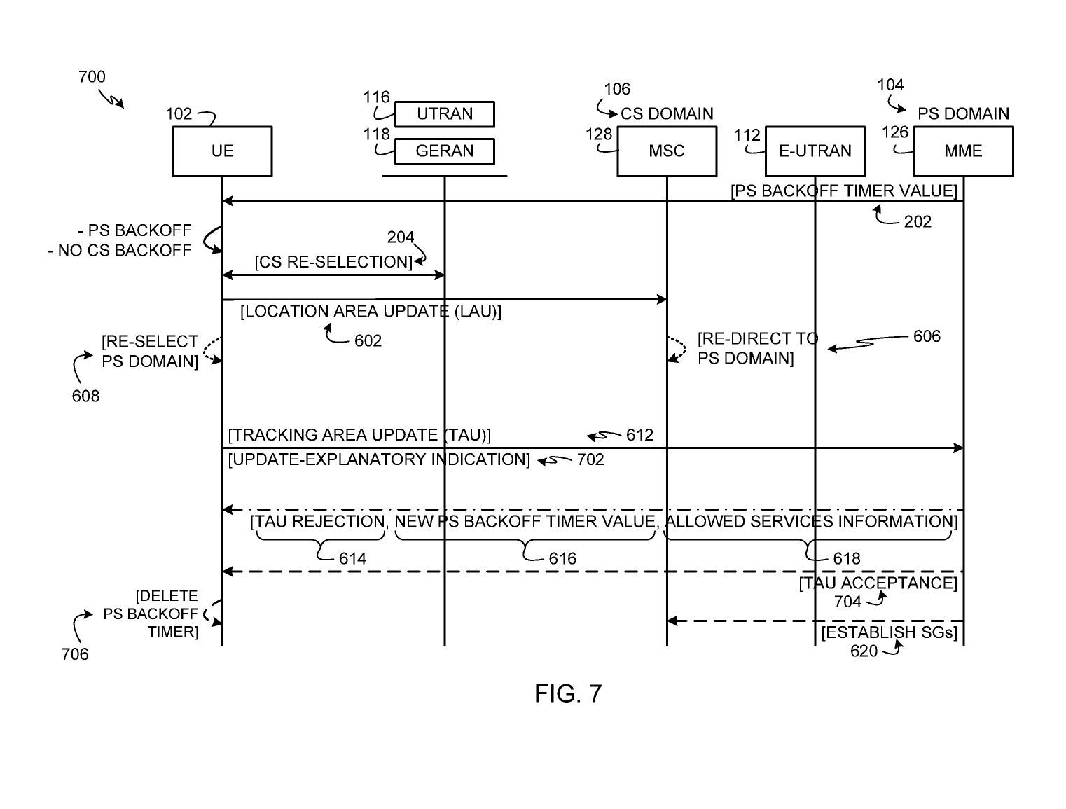

FIG. 7 depicts an example messaging diagram 700 in which the example UE 102 sends the MME 126 the TAU request 612 of FIG. 6 and an update-explanatory indication 702 (e.g., an indication) explaining why the UE 102 is sending the TAU request 612. In the illustrated example of FIG. 7, the update-explanatory indication 702 informs the MME 126 that the UE 102 is performing the TAU due to a previous re-selection to attach to the PS domain 104 that occurred before the CS re-selection 204, or due to the UE 102 needing that the SGs interface 134 (FIG. 1) be established between the MME 126 and the MSC server 128 to, for example, enable CSFB service.

When the MME 126 receives the TAU request 612 and the update-explanatory indication 702 from the UE 102, the MME 126 may accept or reject the TAU request 612 depending on, for example, congestion and/or other factors. If the MME 126 accepts the TAU request 612, the MME 126 sends the UE 102 a TAU acceptance 704 and establishes the SGs interface 134 with the MSC server 128 (FIG. 1) corresponding to the LA provided by the UE 102 as indicated by reference numeral 618. In addition, the UE 102 deletes or clears the PS backoff timer 108 as indicated by reference numeral 706 so that the UE 102 is no longer PS backed off.

Alternatively in the example of FIG. 7, when the MME 126 receives the TAU request 612 and the update-explanatory indication 702 from the UE 102, the MME 126 rejects the TAU request 612 due to, for example, congestion. In such examples, the MME 126 provides one or more of the TAU rejection 614, the new PS backoff timer value 616, and/or the allowed services information 618 to the UE 102. However, because the UE 102 provided the update-explanatory indication 702, the MME 126 may delete a current SGs interface 134 (if one exists for the UE 102) and establish a new SGs interface 134 with an MSC server (e.g., the MSC server 128) selected by the MME 126 in accordance with how the MME 126 selects an MSC server when the UE 102 performs a combined registration (e.g., the TAU 612) with the PS domain 104. In some examples, the MME 126 does not delete a current SGs interface 134 and, instead, may refresh the existing SGs interface 134 with the same MSC server that was previously selected when the SGs interface 134 was established. When the MME 126 sends the TAU rejection 614 to the UE 102, in addition to parameters provided in the TAU rejection 614, the MME 126 may also provide the UE 102 with a location area index (LAI) and a visitor location registration (VLR) temporary mobile subscriber identity (TMSI) as if the TAU request 612 were accepted. In other words, the MME 126 rejects the TAU request 612 and restarts the PS backoff of the UE 102 by sending the new PS backoff timer value 616, but the MME 126 accepts the CS registration of the UE 102.

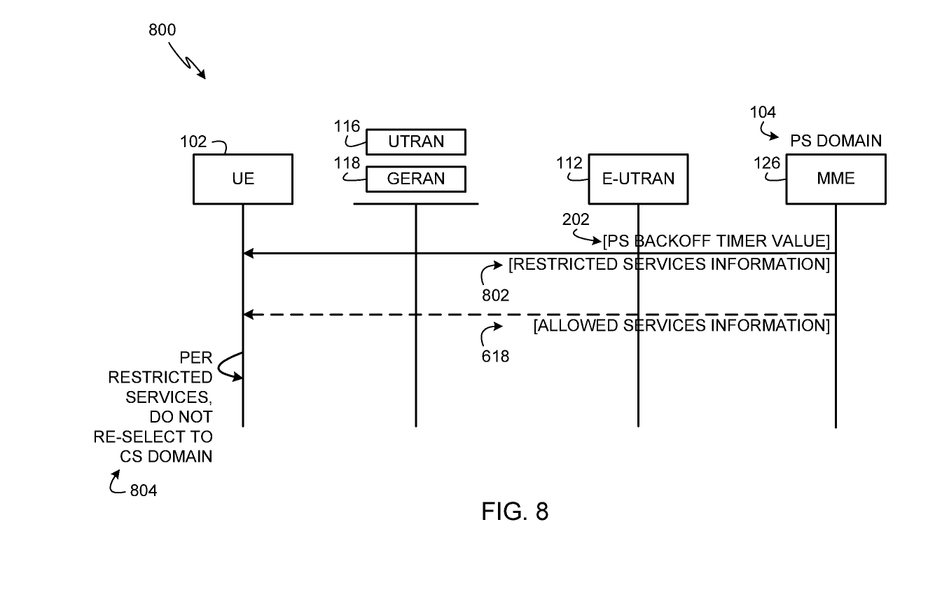

FIG. 8 depicts an example messaging diagram 800 in which, based on restricted services information 802 from the PS domain 104, the example UE 102 does not re-select the CS domain 106. In the illustrated example, when the PS domain 104 PS backs off the UE 102, the PS domain 104 sends the UE 102 the PS backoff timer value 202 and restricted services information 802 (e.g., an indication of restricted services). In the illustrated example, the MME 126 and/or the SGSN 132 of FIG. 1 generate(s) and send(s) the restricted services information 802 via the PS domain 104. The restricted services information 802 of the illustrated example indicates what CS services (e.g., SMS through CS re-selection, voice calling service, USSD service, location services (LCS), CS data services, MO CS services through CS re-selection, etc.) the UE 102 is not allowed to initiate while it is PS backed off (e.g., while the PS backoff timer 108 of FIG. 1 is running). That is, if the UE 102 receives the restricted services information 802 from the PS domain 104 while the PS backof timer 108 is running, the UE 102 is not allowed to re-select to attach to the CS domain 106 to initiate the restricted CS services indicated in the restricted services information 802. Accordingly, the restricted services information 802 is useable to restrict the UE 102 and other UEs from re-selecting to attach to the CS domain 106 at the same time. In this manner, the PS domain 104 can use the restricted services information 802 to prevent flooding of the CS domain 106 when the PS domain 104 PS backs off numerous UEs at substantially the same time. As such, congestion of the CS domain 106 can be prevented or substantially reduced using the restricted services information 802.

In some examples, the restricted services information 802 is referred to as an additional CS service update result that updates the UE 102 on services for which it is not allowed to re-select to the CS domain 106. In some examples, the restricted services information 802 is implemented using an information element (IE) field in a MM service reject message, and the restricted services are indicated using different bit encodings in the IE field. In some examples, each unique bit encoding (e.g., bit encoding 00, 01, 10, 11 in a two-bit IE field) may be used to represent a different restricted service. For example, a bit encoding of 01 in the IE field may indicate that the UE 102 is restricted from re-selecting to the CS domain 106 to access CS voice services when the PS backoff timer 108 is running, and a bit encoding of 10 in the IE field may indicate that the UE 102 is restricted from re-selecting to the CS domain 106 to access SMS messaging services when the PS backoff timer 108 is running. In some examples, multiple restricted services may be indicated together using a single bit encoding. For example, a bit encoding of 01 in the IE field may indicate that the UE 102 is restricted from re-selecting to the CS domain 106 to access one or both of CS voice services and/or SMS messaging services when the PS backoff timer 108 is running.

When the UE 102 receives the restricted services information 802, the UE 102 uses the PS backoff timer value 202 to refrain from performing PS signaling and accessing PS services for the duration of the PS backoff timer value 202. In addition, as indicated by reference numeral 804, the UE 102 does not attempt to re-select to attach to the CS domain 106 to access CS services (e.g., SMS messaging, voice call services, USSD services, LCS, CS data services, etc.) over the CS domain 106 that are indicated as restricted in the restricted services information 802.

In some examples, the PS domain 104 may additionally or alternatively send the UE 102 allowed services information 618 indicative of CS services that the UE 102 is allowed to initiate (e.g., allowed services as described above in connection with the allowed services information 618 of FIG. 6) by re-selecting to attach to the CS domain 106 while the PS backoff timer 108 is running (e.g., the UE 102 is PS backed off) and the CS backoff timer 110 is not running (e.g., the UE 102 is not CS backed off). For example, the CS domain 106 may have sufficient resources to provide UEs with some types of CS services, but the CS domain 106 may have insufficient resources that are needed to provide UEs with other types of CS services. In this manner, the MME 126 and/or the SGSN 132 may prevent flooding of the CS domain 106 by controlling when UEs (e.g., the UE 102) may re-select to the CS domain 106 to initiate CS services indicated in the allowed services information 618 as allowed CS services, and/or to prevent the UEs from re-selecting to the CS domain 106 when desiring to access CS services indicated in the restricted services information 802 as restricted CS services.

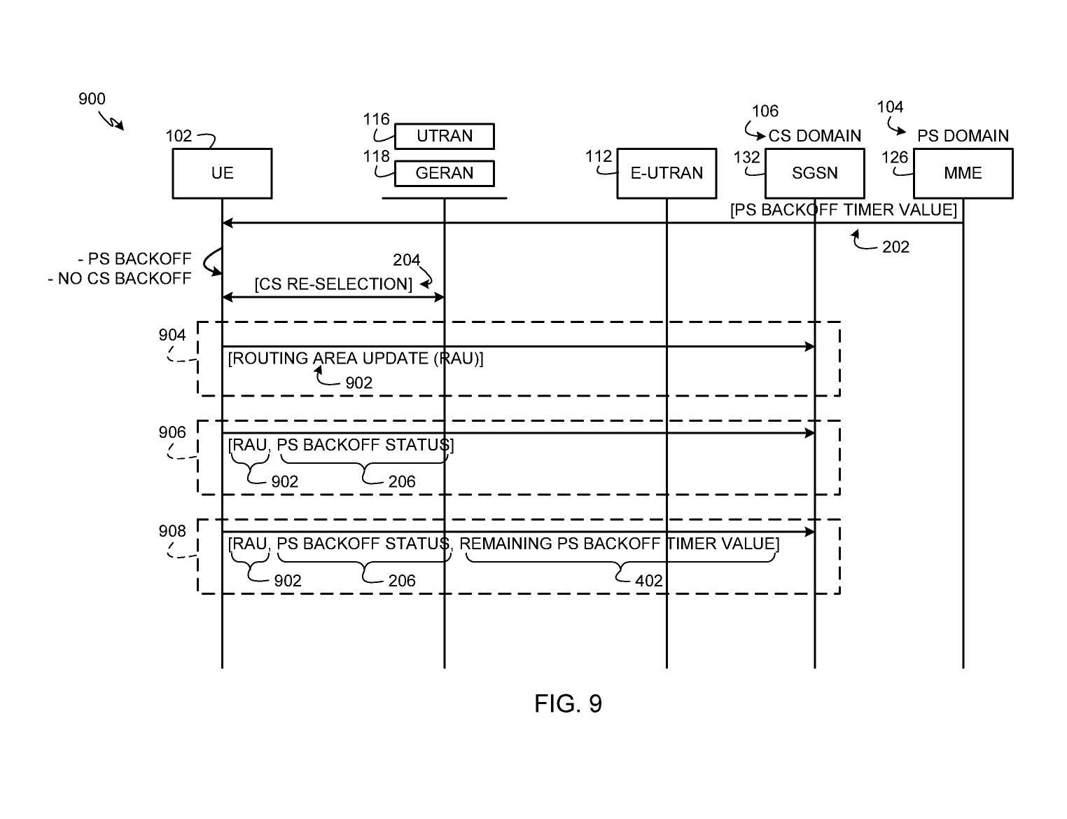

FIG. 9 depicts an example messaging diagram 900 in which the example UE 102 sends a routing area update (RAU) request 902 even when it is PS backed off from the PS domain 104. The example of FIG. 9 may be used in instances in which the UE 102 switches from the E-UTRAN 112 to the UTRAN 116 or the GERAN 118 to access CS service(s) while it is PS backed off, and may also be used when the UE 102 remains camped on the UTRAN 116 or the GERAN 118 in idle mode after completing its use of the CS service(s). In some examples, the UE 102 remains camped on the UTRAN 116 or the GERAN 118 based on idle mode camping policies that it receives from the MSC server 128 of FIG. 1. The example of FIG. 9 may also be used in instances in which the UE 102 switches from the E-UTRAN 112 to the UTRAN 116 or the GERAN 118 to access CS service(s) while it is PS backed off and does not return to the E-UTRAN 112 for the duration that the PS backoff timer 108 is running (e.g., the UE 102 remains on the CS domain 104 while the PS backoff timer 108 has not expired).

The example messaging diagram 900 shows three example selectable options 904, 906, and 908 that the UE 102 may selectively employ. When the UE 102 implements the selectable options 904, 906, and 908, the UE 102 re-selects the UTRAN 116 or the GERAN 118 (e.g., the UE 102 re-selects from a 3GPP-defined S1 mode to a 3GPP-defined Iu mode or to a 3GPP-defined A/GB mode) by performing the CS re-selection procedure 204 with the UTRAN 116 or the GERAN 118 to access CS service(s) (e.g., mobile originated (MO) voice service, MO SMS service, MO USSD service, MO LCS, MO CS data service, etc.) in the CS domain 106. The first selectable option 904 involves the UE 102 also performing a Routing Area Update (RAU) by sending a RAU request 902 to the SGSN 132 of FIG. 1 even if the UE 102 is PS backed off and the PS backoff timer 108 of FIG. 1 is running.

The second selectable option 906 involves the UE 102 sending to the SGSN 132 the RAU request 902 and the PS backoff status 206 indicating that the PS backoff timer 108 (FIG. 1) is running. The third selectable option 908 involves the UE 102 sending to the SGSN 132 the RAU request 902, the PS backoff status 206, and the remaining PS backoff timer value 402. In some examples, the UE 102 performs the RAU (e.g., sending the RAU request 902) of the selectable options 904, 906, and 908 only if the UE 102 has previously performed an LAU.

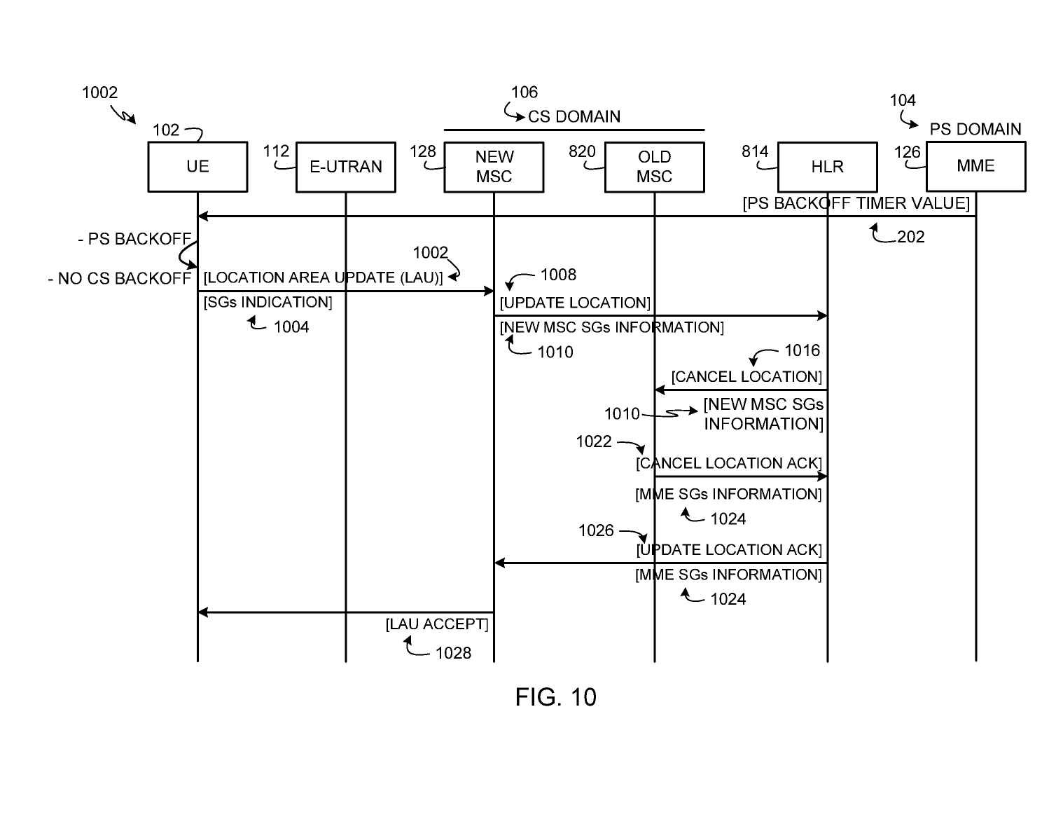

FIG. 10 depicts an example messaging diagram 1000 in which the example UE 102 sends a location area update (LAU) request 1002 to a new mobile switching center (MSC) server 128 to maintain an SGs interface 134 association between the new MSC 128 and a serving MME (e.g., the serving MME 126 of FIG. 1). In the illustrated example of FIG. 10, the UE 102 receives the PS backoff timer value 202 to PS backoff the UE 102. The UE 102 sends the LAU request 1002 to the new MSC 128 when the UE 102 moves to the CS domain 106 during a CSFB procedure. In the illustrated example, the UE 102 also provides an indication (e.g., the PS backoff status 206 of FIGS. 2 and 3) to the CS domain 106 that the UE 102 is PS backed off. In the illustrated example, the UE 102 also sends the new MSC 128 an SGs indication 1004 indicating that the SGs interface 134 must be maintained for the UE 102.

In the illustrated example, the new MSC 128 maintains the SGs interface 134 or creates a new SGs interface 134 between the new serving MSC 128 and the serving MME 126. To maintain or create the SGs interface 134 for the UE 102, the new MSC 128 sends an update location request 1008 and new MSC SGs information 1010 to a home location register (HLR) 1014. In the illustrated example, the HLR 1014 is a database that stores subscriber information (e.g., account information, subscribed features, user preferences, current user location, etc.) that the new MSC 128 uses to handle MO calls from the UE 102 and to deliver MT calls to the UE 102. The new MSC SGs information 1010 of the illustrated example indicates the new MSC server 128 with which to maintain or establish a SGs interface 134 for the UE 102. In response to the update location request 1008 and the new MSC SGs information 1010, the HLR 1014 sends a cancel location request 1016 and the new MSC SGs information 1010 to an old MSC server 1020 with which the UE 102 was previously registered. In the illustrated example, the MSC servers 128 and 1020 also implement visitor location registers (VLRs). The cancel location request 1016 of the illustrated example requests that the old MSC server 1020 cancel the previous LA registered in the old MSC server 1020 for the UE 102. Although not shown, the old MSC server 1020 sends the new MSC SGs information 1010 to the MME 126 (FIG. 1) so that the MME 126 can maintain an SGs interface 134 with the new MSC server 128 or establish a new SGs interface 134 with the new MSC server 128.

The old MSC server 1020 sends a cancel location acknowledgement 1022 and MME SGs information 1024 to the HLR 1014. The MME SGs information 1024 of the illustrated example identifies the SGs interface 134 that is established/maintained between the new MSC server 128 and the MME 126 for the UE 102. When a previously established SGs interface 134 is maintained, the old MSC server 1020 transfers the SGs interface 134 to the new MSC server 128. In the illustrated example, the HLR 1014 sends an update location acknowledgment 1026 and the MME SGs information 1024 to the new MSC server 128, and the new MSC server 128 sends a LAU acceptance 1028 to the UE 102.

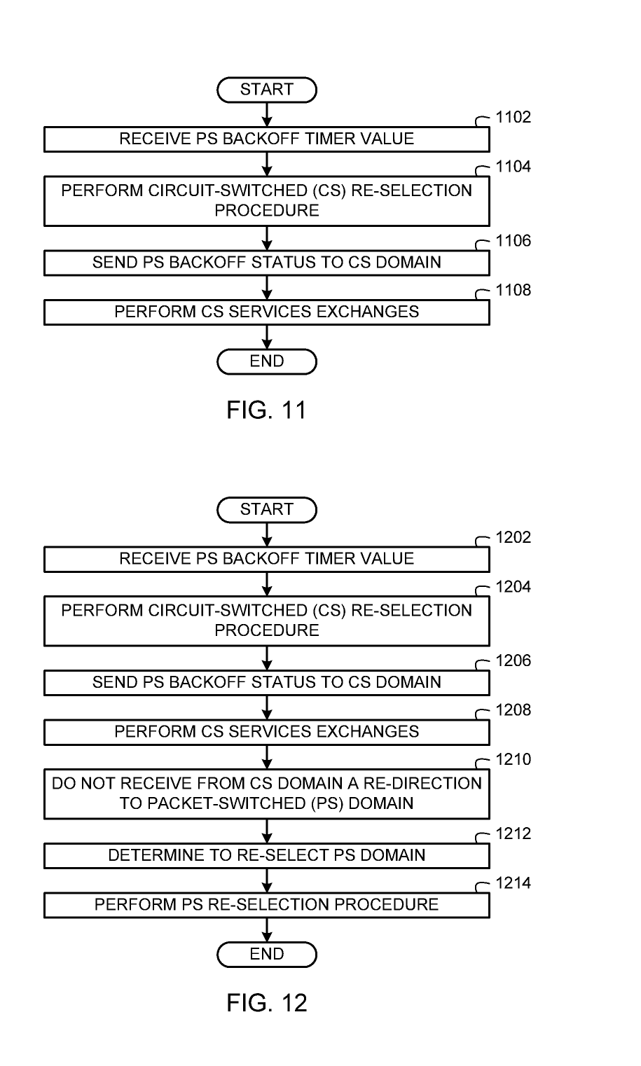

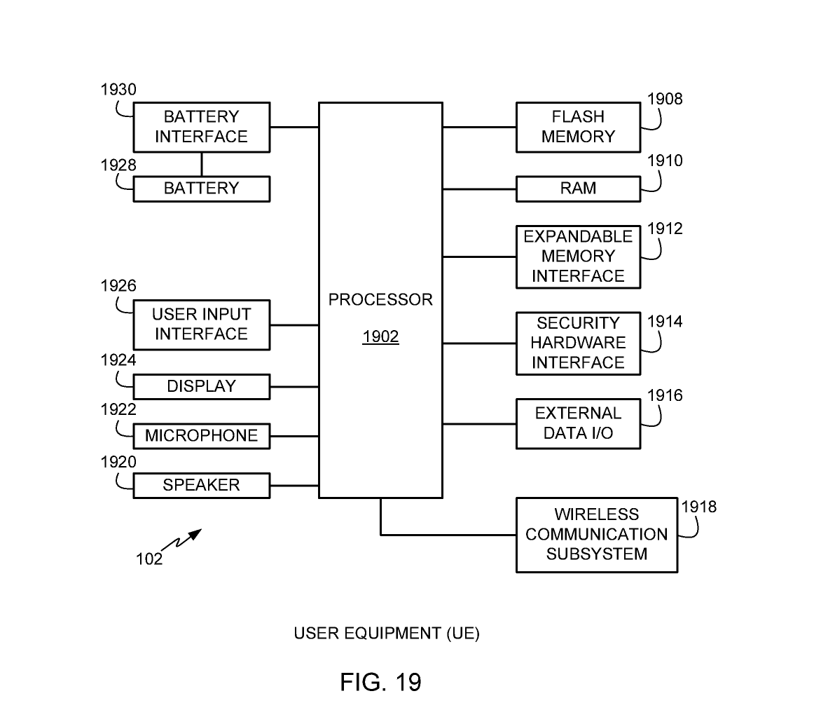

Flowcharts representative of example machine readable instructions for implementing the UE 102 of FIGS. 1-10 are shown in FIGS. 11-18. In such examples, the machine readable instructions comprise one or more programs for execution by a processor such as the processor 1912 shown in the example processor platform 1900 discussed below in connection with FIG. 19. The one or more programs may be embodied in software stored on a tangible computer readable storage medium such as a flash memory, a read-only memory (ROM), a cache, a random-access memory (RAM), a CD-ROM, a floppy disk, a hard drive, a digital versatile disk (DVD), a Blu-ray disk, or a memory associated with the processor 1912, but the entire program(s) and/or parts thereof could alternatively be executed by a device other than the processor 1912 and/or embodied in firmware or dedicated hardware. Further, although the example program(s) is/are described with reference to the flowcharts illustrated in FIGS. 11-18, many other methods of implementing the example UE 102 may alternatively be used. For example, the order of execution of the blocks may be changed, and/or some of the blocks described may be changed, eliminated, or combined.

As mentioned above, the example processes of FIGS. 11-18 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 11-18 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 11 is a flow diagram representative of an example method to implement the example messaging diagram 200 of FIG. 2 to send a PS backoff status of the UE 102 to the CS domain 106 when the UE 102 requests to attach to the CS domain 106. Initially, the UE 102 receives a PS backoff timer value (block 1102) from the PS domain 104. For example, the UE 102 receives the PS backoff timer value 202 (FIG. 2) provided by the PS domain 104 to PS backoff the UE 102 for the duration of the PS backoff timer value 202. As discussed above in connection with FIG. 2, the UE 102 loads the PS backoff timer value 202 in its PS backoff timer 108 to track the duration for which the UE 102 is PS backed off. The UE 102 performs a CS re-selection procedure (block 1104). For example, the UE 102 performs the CS re-selection procedure 204 (FIG. 2) to re-select the UTRAN 116 or the GERAN 118 to access the CS domain 106. In addition, the UE 102 sends its PS backoff status to the CS domain 106 (block 1106). For example, the UE 102 sends the PS backoff status 206 (FIG. 2) to inform the CS domain 106 that the UE 102 is PS backed off. The UE 102 then performs CS services exchanges with the CS domain (block 1108). For example, the UE 102 performs the CS services exchanges 208 to setup and perform requested CS services. The example method of FIG. 11 then ends.

FIG. 12 is a flow diagram representative of an example method to implement the example messaging diagram 300 of FIG. 3 to send a PS backoff status of the UE 102 to the CS domain 106 and to re-select the PS domain 104. Initially, the UE 102 receives the PS backoff timer value 202 (block 1202) from the PS domain 104 (e.g., as described above in connection with FIG. 2). The UE 102 performs the CS re-selection procedure 204 (block 1204) (e.g., as described above in connection with FIG. 2), for example, to re-select the UTRAN 116 or the GERAN 118 to access the CS domain 106. In addition, the UE 102 sends its PS backoff status 206 to the CS domain 106 (block 1206) (e.g., as described above in connection with FIG. 2). The UE 102 then performs the CS services exchanges 208 with the CS domain (block 1208) (e.g., as described above in connection with FIG. 2).

The UE 102 does not receive from the CS domain 106 a re-direction to the PS domain 104 (block 1210). In the illustrated example, the CS domain 106 does not re-direct the UE to the PS domain (as represented by reference numeral 302 of FIG. 3) as described above in connection with FIG. 3. The UE 102 autonomously determines to re-select to attach to the PS domain 104 (block 1212). In the illustrated example, the UE 102 determines when to re-select to the PS domain 104 (as represented by reference numeral 304 of FIG. 3) as described above in connection with FIG. 3. The UE 102 performs a PS re-selection procedure (block 1214). For example, the UE 102 performs the PS re-selection procedure 306 (FIG. 3) to re-select the E-UTRAN 112 (FIGS. 1 and 3) to attach to the PS domain 104 after the UE 102 finishes using its requested CS services on the CS domain 106. The example method of FIG. 12 then ends.

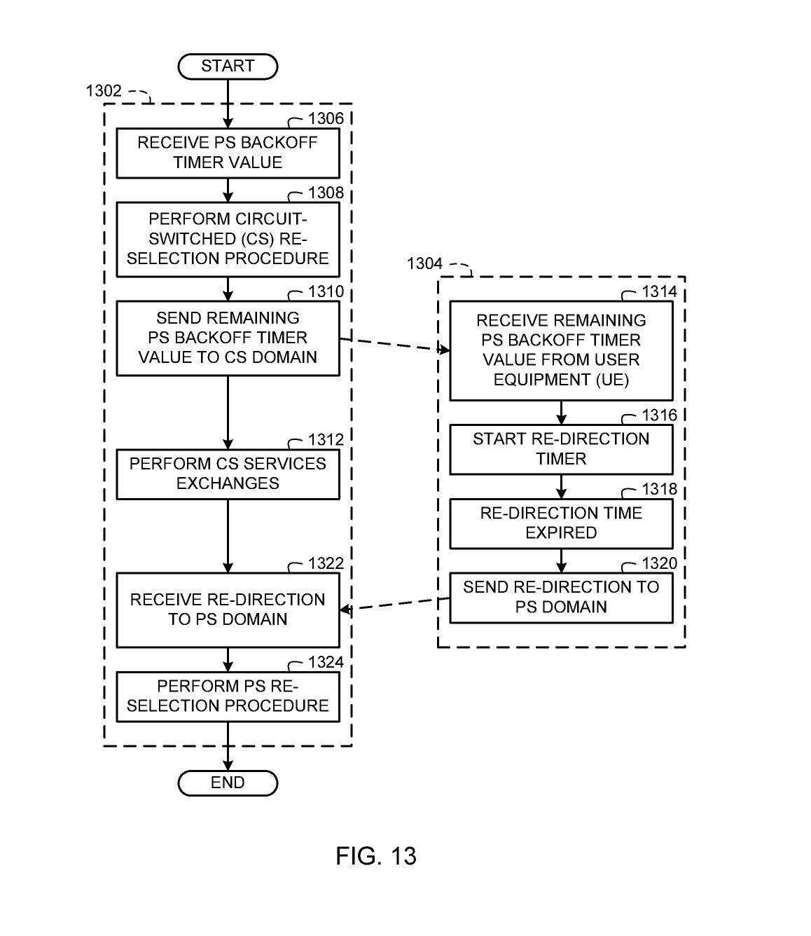

FIG. 13 is a flow diagram representative of example methods of the UE 102 and the CS domain 106 to implement the example messaging diagram 400 of FIG. 4. The illustrated examples of FIG. 13 involve sending a PS backoff timer value from the UE 102 to the CS domain 106, and using a re-direction timer at the CS domain 106 to determine when to re-direct the UE 102 to the PS domain 104. In the illustrated example of FIG. 13, an example method 1302 is performed by the UE 102, and an example method 1304 is performed by the CS domain 106 (e.g., the UTRAN 116 and/or the GERAN 118 of FIGS. 1 and 4).

Initially in the example method 1302 of FIG. 13, the UE 102 receives the PS backoff timer value 202 (block 1302) from the PS domain 104 (e.g., as described above in connection with FIG. 2). The UE 102 performs the CS re-selection procedure 204 (block 1204) (e.g., as described above in connection with FIG. 2), for example, to re-select the UTRAN 116 or the GERAN 118 to access the CS domain 106. In addition, the UE 102 sends a remaining PS backoff timer value to the CS domain 106 (block 1310). In the illustrated example, the UE 102 sends its remaining PS backoff timer value 402 (FIG. 4) to the CS domain 106 as described above in connection with FIG. 4. The UE 102 then performs the CS services exchanges 208 (block 1312) (e.g., as described above in connection with FIG. 2).

In the example method 1304 of FIG. 13, the CS domain 106 receives the remaining PS backoff timer value 402 from the UE 102 (block 1314). The CS domain 106 starts a re-direction timer (block 1316). For example, the CS domain 106 starts a re-direction timer (as represented by reference numeral 404 of FIG. 4) as described above in connection with FIG. 4. The CS domain 106 determines when the re-direction timer has expired (block 1318). For example, the CS domain 106 determines when the re-direction timer has expired as represented by reference numeral 406 of FIG. 4. When the re-direction timer has expired (block 1318), the CS domain 106 sends the UE 102 a request to re-direct the UE 102 to the PS domain 104 (block 1320). For example, the CS domain 106 sends the re-direction 408 of FIG. 4 (re-direct to PS domain) to the UE 102 as described above in connection with FIG. 4.

In the example method 1302, the UE 102 receives the re-direction 408 to the PS domain 104 (block 1322). The UE 102 performs a PS re-selection procedure to the PS domain 104 (block 1324). For example, the UE 102 performs the PS re-selection procedure 410 of FIG. 4 to re-select the E-UTRAN 112 (FIGS. 1 and 4) to attach to the PS domain 104. The example method of FIG. 13 then ends.

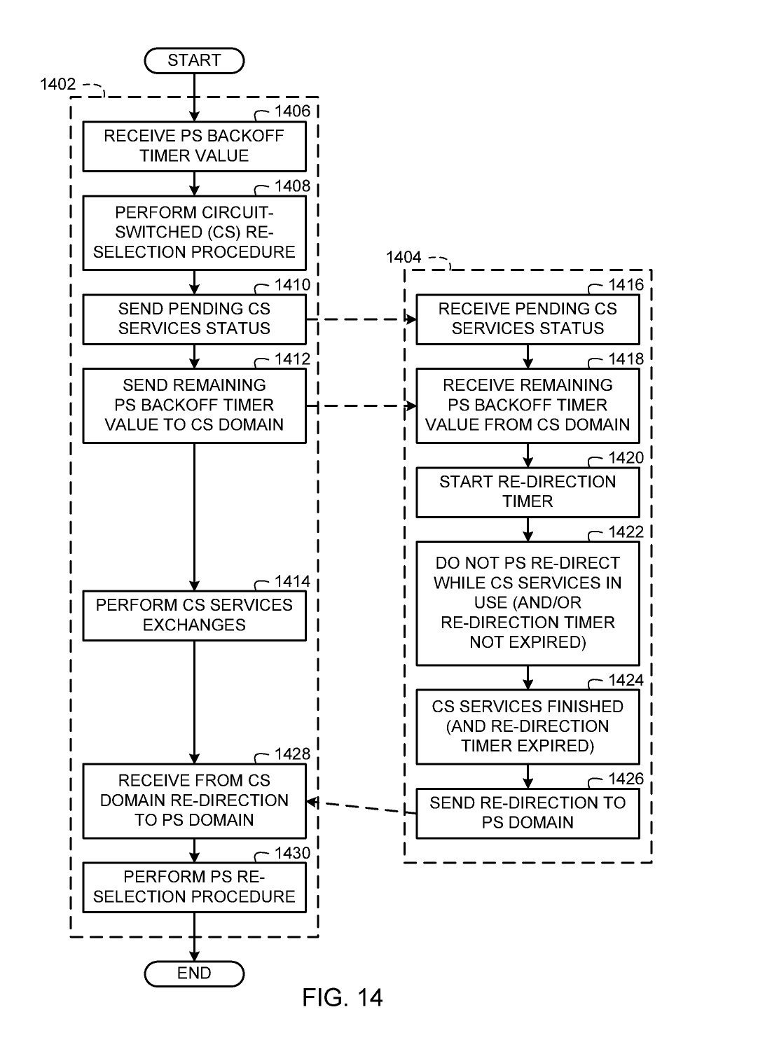

FIG. 14 is a flow diagram representative of example methods of the UE 102 and the CS domain 106 to implement the example messaging diagram 500 of FIG. 5. The illustrated examples of FIG. 14 involve sending a listing of requested/pending CS services from the UE 102 to the CS domain 106, and re-directing the UE 102 from the CS domain 106 to the PS domain 104 after the UE 102 has finished using the requested/pending CS services. In the illustrated example of FIG. 14, an example method 1402 is performed by the UE 102, and an example method 1404 is performed by the CS domain 106 (e.g., the UTRAN 116 and/or the GERAN 118 of FIGS. 1 and 4).

Initially in the example method 1402 of FIG. 14, the UE 102 receives the PS backoff timer value 202 (block 1406) from the PS domain 104 (e.g., as described above in connection with FIG. 2). The UE 102 performs the CS re-selection procedure 204 to the CS domain 106 (block 1408) (e.g., as described above in connection with FIG. 2), for example, to re-select the UTRAN 116 or the GERAN 118 to access the CS domain 106. In addition, the UE 102 sends a pending CS services status to the CS domain 106 (block 1410). For example, the UE 102 sends the pending CS services status 502 to the CS domain 106 as described above in connection with FIG. 5. In some examples, the UE 102 also sends its remaining PS backoff timer value 402 (FIG. 4) to the CS domain 106 (block 1412). The UE 102 then performs the CS services exchanges 208 and 506 (block 1414) (e.g., as described above in connection with FIGS. 2 and 5).

In the example method 1404 of FIG. 14, the CS domain 106 receives the pending CS services status 502 from the UE 102 (block 1416). In examples, in which the UE 102 also sends its remaining PS backoff timer value 402 at block 1412, the CS domain 106 receives the remaining PS backoff timer value 402 from the UE 102 (block 1418), and the CS domain 106 starts a re-direction timer (block 1420) (e.g., the CS domain 106 starts a re-direction timer as represented by reference numeral 404 of FIG. 4). In examples in which the UE 102 does not send its remaining PS backoff timer value 402, blocks 1418 and 1420 of FIG. 14 are omitted from the example method 1404.

In the illustrated example, the CS domain 106 does not send a PS re-direct request to the UE 102 while the UE 102 is still using the requested/pending CS services (block 1422) indicated in the pending CS services status 502. For example, the CS domain 106 does not re-direct the UE 102 to the PS domain 104 as represented by reference numeral 504 of FIG. 5. In examples in which the UE 102 provided its remaining PS backoff timer value 402 at block 1412, block 1422 involves the CS domain 106 not re-directing the UE 102 to the PS domain 104 (reference numeral 504 of FIG. 5) while the UE 102 is still using the requested/pending CS services 502 and/or while the re-direction timer maintained by the CS domain 106 is not expired. In such examples, the CS domain 106 does not re-direct the UE 102 to the PS domain 104 until meeting both conditions including that the UE 102 has finished using the requested/pending CS services 502 and that the re-direction timer maintained by the CS domain 106 has expired.

The CS domain 106 determines when the UE 102 has finished using the requested/pending CS services 502 (block 1424). In examples in which the UE 102 provided its remaining PS backoff timer value 402 at block 1412, block 1424 also involves the CS domain 106 determining that the re-direction timer maintained by the CS domain 106 has expired. The CS domain 106 then sends the UE 102 a request to re-direct the UE 102 to the PS domain 104 (block 1426). For example, the CS domain 106 sends the re-direction 508 of FIG. 5 (re-direct to PS domain) to the UE 102 as described above in connection with FIG. 5.

In the example method 1302, the UE 102 receives the re-direction 508 to the PS domain 104 (block 1428). The UE 102 performs a PS re-selection procedure (block 1430). For example, the UE 102 performs the PS re-selection procedure 410 of FIG. 5 to re-select the E-UTRAN 112 (FIGS. 1 and 5) to attach to the PS domain 104. The example method of FIG. 14 then ends.

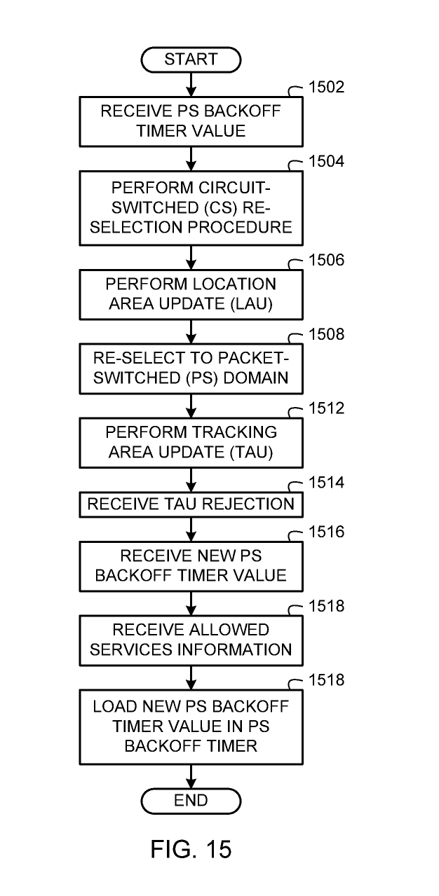

FIG. 15 is a flow diagram representative of an example method to implement the example messaging diagram 600 of FIG. 6. In the illustrated example of FIG. 15, the UE 102 performs a location area update (LAU), and a tracking area update (TAU) with the PS domain 104 to receive PS services and circuit-switched (CS) fallback (CSFB) services from the PS domain 104.

Initially, the UE 102 receives the PS backoff timer value 202 (block 1502) from the PS domain 104 (e.g., as described above in connection with FIG. 2). The UE 102 performs the CS re-selection procedure 204 (block 1504) (e.g., as described above in connection with FIG. 2), for example, to re-select the UTRAN 116 or the GERAN 118 to access the CS domain 106. The UE 102 performs a LAU (block 1506). For example, the UE 102 sends the LAU request 602 to the MSC 128 (FIGS. 1 and 6) to perform a LAU as described above in connection with FIG. 6.

The UE 102 determines to re-select to the PS domain 104 (block 1508). For example, the UE 102 may receive a re-direct 606 (FIG. 6) to the PS domain 104, or may autonomously determine to re-select to the PS domain 104 as represented by reference numeral 608 of FIG. 6. After returning to the PS domain 104, the UE 102 performs a TAU (block 1512). For example, if the UE 102 has performed an LAU (e.g., the LAU at block 1506) while the UE 102 is attached to the UTRAN 116 or the GERAN 118, the UE 102 sends the TAU request 612 to the MME 126 (FIGS. 1 and 6) to perform a TAU as described above in connection with FIG. 6 even if the UE 102 is still PS backed off.

In the illustrated example, the UE 102 receives a TAU rejection (block 1514). For example, the UE 102 receives the TAU rejection 614 from the MME 126 as described above in connection with FIG. 6. In the illustrated example, the UE 102 also receives the new PS backoff timer value 616 (block 1516) as described above in connection with FIG. 6. In the illustrated example, the UE 102 also receives the allowed services information 618 (block 1518) as described above in connection with FIG. 6. In the illustrated example, the UE 102 loads the new PS backoff timer value 616 in its PS backoff timer 108 (block 1520). In this manner, the UE 102 can load and run its PS backoff timer 108 with the new PS backoff timer value 616 so that the UE 102 remains PS backed off for the duration of the new PS backoff timer value 616. As described above in connection with FIG. 6, the MME 126 establishes the SGs interface 134 (FIG. 1) with the MSC server 128 (FIG. 1) corresponding to the LA provided by the UE 102 as indicated by reference numeral 620. The example method of FIG. 15 then ends.

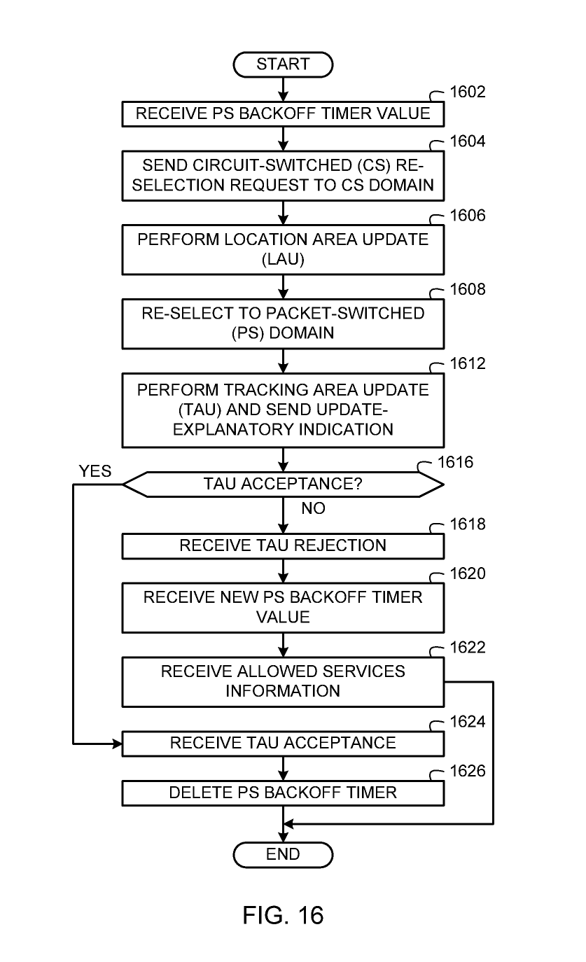

FIG. 16 is a flow diagram representative of an example method to implement the example messaging diagram 700 of FIG. 7. In the illustrated example, the UE 102 sends information while performing a TAU to explain why the UE 102 is performing the TAU. Initially, the UE 102 receives the PS backoff timer value 202 (block 1602) from the PS domain 104 (e.g., as described above in connection with FIG. 2). The UE 102 performs the CS re-selection procedure 204 (block 1604) (e.g., as described above in connection with FIG. 2), for example, to re-select the UTRAN 116 or the GERAN 118 to access the CS domain 106. The UE 102 performs a LAU (block 1606). For example, the UE 102 sends the LAU request 602 to the MSC 128 (FIGS. 1 and 6) to perform a LAU as described above in connection with FIG. 6.

The UE 102 determines to re-select to the PS domain 104 (block 1608). For example, the UE 102 may receive a re-direct 606 (FIGS. 6 and 7) to the PS domain 104, or may autonomously determine to re-select to the PS domain 104 as represented by reference numeral 608 of FIGS. 6 and 7. After returning to the PS domain 104, the UE 102 performs a combined TAU and sends an update-explanatory indication to the MME 126 (block 1612). For example, the UE 102 sends the TAU request 612 (FIGS. 6 and 7) to the MME 126 (FIGS. 1 6, and 7) to perform a TAU and a combined registration as described above in connection with FIG. 6. At block 1612 of the illustrated example, the UE 102 also sends the update-explanatory indication 702 (FIG. 7) to the MME 126 when performing the TAU as described above in connection with FIG. 7.

In the illustrated example, the UE 102 determines whether the MME 126 has accepted the TAU (block 1616). For example, the MME 126 may accept or reject the TAU request 612 of block 1612 depending on, for example, congestion and/or other factors as described above in connection with FIG. 7. If the MME 126 does not accept the TAU (block 1616), the UE 102 receives the TAU rejection 614 of FIG. 7 (block 1618). In addition, the UE 102 receives the new PS backoff timer value 616 of FIG. 7 (block 1620). In this manner, the UE 102 can load and run its PS backoff timer 108 with the new PS backoff timer value 616 so that the UE 102 remains PS backed off for the duration of the new PS backoff timer value 616. However, because the UE 102 provided the update-explanatory indication 702 to the MME 126, the MME 126 may delete or refresh a current SGs interface 134 (FIG. 1) associated with the UE 102 as described above in connection with FIG. 7. In the illustrated example, the UE 102 also receives the allowed services information 618 (block 1622) as described above in connection with FIG. 6. The example method of FIG. 16 then ends.

If the MME 126 accepts the TAU (block 1616), the UE 102 receives the TAU acceptance 704 of FIG. 7 (block 1624). In addition, the UE 102 deletes or clears the PS backoff timer 108 of FIG. 1 (block 1626), for example, as indicated by reference numeral 706 of FIG. 7 so that the UE 102 is no longer PS backed off. As described above in connection with FIG. 7, the MME 126 also establishes the SGs interface 134 with the MSC server 128 (FIGS. 1 and 7) corresponding to the location area (LA) provided by the UE 102 as indicated by reference numeral 620 of FIG. 7. The example method of FIG. 16 then ends.

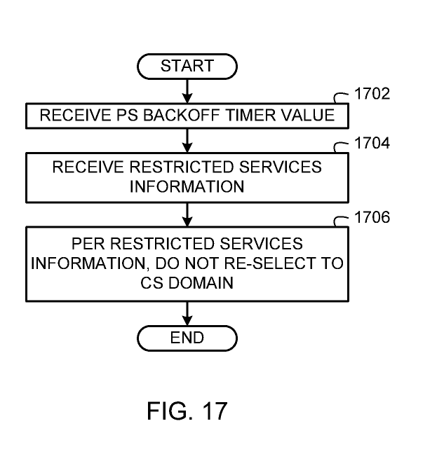

FIG. 17 is a flow diagram representative of an example method to implement the example messaging diagram 800 of FIG. 8 to cause the UE 102 to refrain from re-selecting the CS domain 106 based on services indicated by the PS domain 104 as restricted. Initially, the UE 102 receives the PS backoff timer value 202 (block 1702) from the PS domain 104 (e.g., as described above in connection with FIG. 2). The UE 102 also receives restricted services information 802 of FIG. 8 (block 1704) from the PS domain 104. Based on the restricted services information 802, the UE 102 does not re-select to the CS domain 106 (block 1706), for example, as described above in connection with FIG. 8. The example method of FIG. 17 then ends.

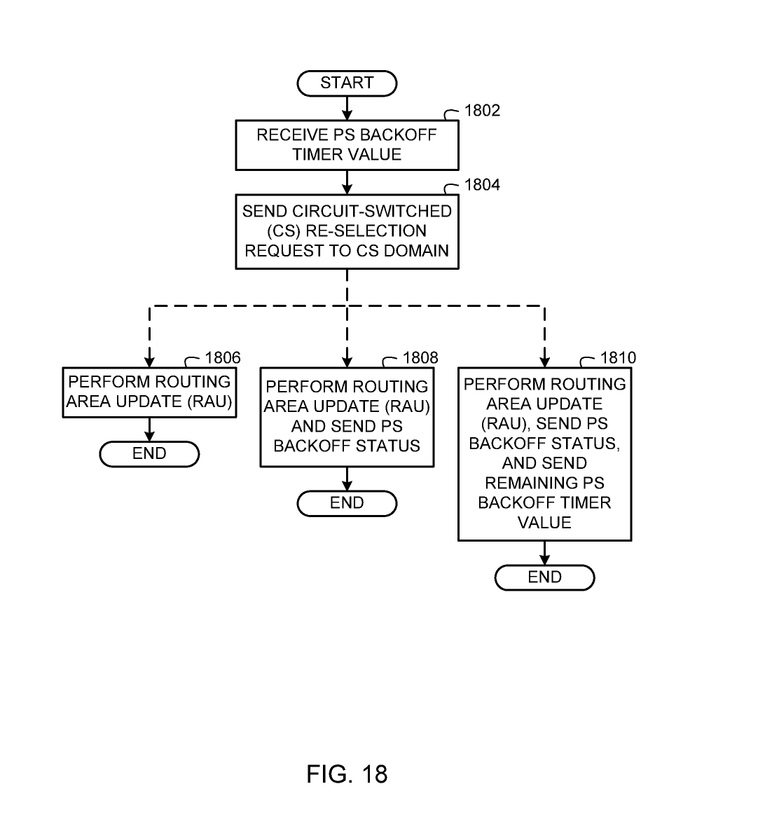

FIG. 18 is a flow diagram representative of an example method to implement the example messaging diagram 900 of FIG. 9. The example method of FIG. 9 enables the UE 102 to perform a routing area update (RAU) in different manners. Initially, the UE 102 receives the PS backoff timer value 202 (block 1802) from the PS domain 104 (e.g., as described above in connection with FIG. 2). The UE 102 performs the CS re-selection procedure 204 (block 1804) (e.g., as described above in connection with FIG. 2), for example, to re-select the UTRAN 116 or the GERAN 118 to access the CS domain 106. In some examples, the UE 102 performs a RAU (block 1806) by sending the RAU request 1002 to the serving GPRS (general packet radio service) support node (SGSN) 132 (FIGS. 1 and 9) as described above in connection with the example selectable option 904 of FIG. 9. The example method of FIG. 18 then ends.

In some examples, the UE 102 performs a RAU and sends a PS backoff status (block 1808) to the SGSN 132. For example, the UE 102 sends the RAU request 1002 including the PS backoff status 206 to the SGSN 132 as described above in connection with the example selectable option 906 of FIG. 9. The example method of FIG. 18 then ends.

In some examples, the UE 102 performs a RAU, sends a PS backoff status, and sends a remaining PS backoff timer value (block 1810) to the SGSN 132. For example, the UE 102 sends the RAU request 1002 including the PS backoff status 206 and the remaining PS backoff timer value 402 to the SGSN 132 as described above in connection with the example selectable option 908 of FIG. 9. The example method of FIG. 18 then ends.

FIG. 19 depicts an example processor system that may be used to implement the example UE 102 of FIGS. 1-10 to implement example methods disclosed herein. In the illustrated example, the UE 102 includes a processor 1902 that may be used to control the overall operation of the UE 102. The processor 1902 may be implemented using a controller, a general purpose processor, a digital signal processor, or any combination thereof. The UE 102 also includes a FLASH memory 1908, a random access memory (RAM) 1910, and an expandable memory interface 1912 communicatively coupled to the processor 1902. The FLASH memory 1908 can be used to, for example, store computer readable instructions, data, and/or received messages or requests. The RAM 1910 can also be used to, for example, store data and/or instructions.

The UE 102 is optionally provided with a security hardware interface 1914 to receive a subscriber identity module (SIM) card (or a universal SIM (USIM) card or a near field communication (NFC) secure element) from a wireless service provider. A SIM card may be used as an authentication parameter to authenticate the UE 102 for establishing a connection with a database (e.g., an authentication database, the MME 126, the MSC 128, and/or the SGSN 132 of FIG. 1 and/or the HLR 1014 of FIG. 10) and/or an access network (e.g., the E-UTRAN 112, the UTRAN 116, and/or the GERAN 118 of FIG. 1). The UE 102 is also provided with an external data I/O interface 1916. The external data I/O interface 1916 may be used by a user to transfer information to the UE 102 through a wired medium (e.g., Ethernet, universal serial bus (USB), etc.).

The UE 102 is provided with a wireless communication subsystem 1918 to enable wireless communications with access networks (e.g., the E-UTRAN 112, the UTRAN 116, and/or the GERAN 118 of FIG. 1). Although not shown, the UE 102 may also have a long-range communication subsystem to receive messages from, and send messages to, a cellular wireless network. In the illustrated examples described herein, the wireless communication subsystem 1918 can be configured in accordance with the Long Term Evolution (LTE) standards, GSM standards, 3GPP standards, and/or any other suitable wireless communication standards. In some example implementations, the wireless communication subsystem 1918 may be provided with multiple radio transceivers for multiple types of radio access technologies. For example, the wireless communication subsystem 1918 may also include a BLUETOOTH® radio, a ZIGBEE® device, a wireless USB device, a radio frequency identification (RFID) device, an NFC device, or an ultra-wideband (UWB) radio.

To enable a user to use and interact with or via the UE 102, the UE 102 is provided with a speaker 1920, a microphone 1922, a display 1924, and a user input interface 1926. The display 1924 may be an LCD display, an e-paper display, etc. The user input interface 1926 could be an alphanumeric keyboard and/or telephone-type keypad, a multi-direction actuator or roller wheel with dynamic button pressing capability, a touch panel, etc. In the illustrated example, the UE 102 is a battery-powered device and is, thus, provided with a battery 1928 and a battery interface 1930.

Although certain methods, apparatus, and articles of manufacture have been disclosed herein, the scope of coverage of this patent is not limited thereto. To the contrary, this patent covers all methods, apparatus, and articles of manufacture fairly falling within the scope of the claims either literally or under the doctrine of equivalents.

What is claimed is:

1. A method to handle services during device backoff, comprising:
maintaining a device backed off from a packet-switched domain;
when the device is backed off from the packet-switched domain, sending a request to attach the device to an access network in a circuit-switched domain; and
sending a packet-switched backoff status of the device with the request, the packet-switched backoff status indicating that the device is backed off from the packet-switched domain.

2. A method as defined in claim 1, further comprising sending a packet-switched backoff timer value of the device with the request, the packet-switched backoff timer value indicating an amount of time remaining until the device is no longer backed off from the packet-switched domain.

3. A method as defined in claim 1, further comprising sending a pending circuit-switched services status of the device with the request, the pending circuit-switched services status indicating circuit-switched services to be used by the device.

4. A method as defined in claim 3, further comprising sending a packet-switched backoff timer value of the device with the request and the pending circuit-switched services status, the packet-switched backoff timer value indicating an amount of time remaining until the device is no longer backed off from the packet-switched domain.

5. A method as defined in claim 3, further comprising receiving a re-direct message from the circuit-switched domain after using the circuit-switched services in the circuit-switched domain, and re-selecting to attach the device to the packet-switched domain based on the re-direct message.

6. A method as defined in claim 1, further comprising, after performing a location area update:
sending a request to register with the packet-switched domain; and
sending a tracking area update request and an update-explanatory indication, the update-explanatory indication providing a reason for the tracking area update request.

7. A method as defined in claim 1, further comprising sending a routing area update request, a packet-switched backoff status of the device, and a packet-switched backoff timer status of the device to a serving general packet radio service support node, the packet-switched backoff status indicating that the device is backed off from the packet-switched domain, and the packet-switched backoff timer status indicating that a packet-switched backoff timer for the device is active.

8. A method to handle services during device backoff, comprising:
receiving, at a device, a packet-switched backoff timer value, and restricted circuit-switched domain services information from a packet-switched domain; and
when the device is backed off from the packet-switched domain, refraining from re-selecting to attach the device to the circuit-switched domain based on the circuit-switched domain services information.

9. An apparatus to handle services during device backoff, comprising:
a processor configured to:
maintain a device backed off from a packet-switched domain;
when the device is backed off from the packet-switched domain, send a request to attach the device to an access network in a circuit-switched domain; and
send a packet-switched backoff status of the device with the request, the packet-switched backoff status indicating that the device is backed off from the packet-switched domain.

10. An apparatus as defined in claim 9, wherein the processor is further configured to send a packet-switched backoff timer value of the device with the request, the packet-switched backoff timer value indicating an amount of time remaining until the device is no longer backed off from the packet-switched domain.

11. An apparatus as defined in claim 9, wherein the processor is further configured to send a pending circuit-switched services status of the device with the request, the pending circuit-switched services status indicating circuit-switched services to be used by the device.

12. An apparatus as defined in claim 11, wherein the processor is further configured to send a packet-switched backoff timer value of the device with the request and the pending circuit-switched services status, the packet-switched backoff timer value indicating an amount of time remaining until the device is no longer backed off from the packet-switched domain.

13. An apparatus as defined in claim 11, wherein the processor is further configured to receive a re-direct message from the circuit-switched domain after using the circuit-switched services in the circuit-switched domain, and to re-select to attach the device to the packet-switched domain based on the re-direct message.

14. An apparatus as defined in claim 9, wherein the processor is further configured to, after performing a location area update:
send a request to register with the packet-switched domain; and
send a tracking area update request and an update-explanatory indication, the update-explanatory indication providing a reason for the tracking area update request.

15. An apparatus as defined in claim 9, wherein the processor is further configured to send a routing area update request, a packet-switched backoff status of the device, and a packet-switched backoff timer status of the device to a serving general packet radio service support node, the packet-switched backoff status indicating that the device is backed off from the packet-switched domain, and the packet-switched backoff timer status indicating that a packet-switched backoff timer for the device is active.

16. A tangible machine readable storage medium comprising instructions that, when executed, cause a device to at least:
maintain the device backed off from a packet-switched domain;
when the device is backed off from the packet-switched domain, send a request to attach the device to an access network in a circuit-switched domain; and
send a packet-switched backoff status of the device with the request, the packet-switched backoff status indicating that the device is backed off from the packet-switched domain.

17. A tangible machine readable storage medium as defined in claim 16, wherein the instructions further cause the device to send a packet-switched backoff timer value of the device with the request, the packet-switched backoff timer value indicating an amount of time remaining until the device is no longer backed off from the packet-switched domain.

18. A tangible machine readable storage medium as defined in claim 16, wherein the instructions further cause the device to send a pending circuit-switched services status of the device with the request, the pending circuit-switched services status indicating circuit-switched services to be used by the device.

19. A tangible machine readable storage medium as defined in claim 18, wherein the instructions further cause the device to send a packet-switched backoff timer value of the device with the request and the pending circuit-switched services status, the packet-switched backoff timer value indicating an amount of time remaining until the device is no longer backed off from the packet-switched domain.

20. A tangible machine readable storage medium as defined in claim 18, wherein the instructions further cause the device to receive a re-direct message from the circuit-switched domain after using the circuit-switched services in the circuit-switched domain, and to re-select to attach the device to the packet-switched domain based on the re-direct message.
